(19) United States
(12) Patent Application Publication
(10) Pub. No.: US 2018/0043718 A1
(43) Pub. Date: Feb. 15, 2018

(54) MATTE COATING COMPOSITION, DECORATIVE MATERIAL AND METHOD FOR PRODUCING SAME

(71) Applicants: TOYO INK SC HOLDINGS CO., LTD., Tokyo (JP); TOYO INK CO., LTD., Tokyo (JP)

(72) Inventors: Sayaka MASUBUCHI, Tokyo (JP); Isao FUKAYAMA, Tokyo (JP); Shigeki MINE, Tokyo (JP); Katsuyuki UEKI, Tokyo (JP)

(73) Assignees: TOYO INK SC HOLDINGS CO., LTD., Tokyo (JP); TOYO INK CO., LTD., Tokyo (JP)

(21) Appl. No.: 15/672,315

(22) Filed: Aug. 9, 2017

(30) Foreign Application Priority Data
Aug. 9, 2016 (JP) 2016-156582

(51) Int. Cl. B41M 5/50; B41M 7/00; C09D 175/06; C09D 5/28; C09D 7/00; C09D 7/12; B41F 23/04; B05D 3/06

(52) U.S. Cl. CPC B41M 5/502; B41F 23/04; B41M 7/0054; B05D 3/068; C09D 5/28; C09D 7/005; C09D 7/1216; C09D 7/1266; C09D 175/06; C08K 3/36

(57) ABSTRACT

A matte coating composition is provided which, while exhibiting low gloss, has high levels of transparency and various resistance properties. Also provided are a decorative material having superior design aesthetics that uses the above matte coating composition, and a method for producing the decorative material. A matte coating composition used for forming a surface protective layer that can utilize gloss difference to portray an uneven three-dimensional feel, wherein the matte coating composition contains a silica and a binder component, and is at least one of heat-curable and ionizing radiation-curable, the silica has an average particle size determined by a laser diffraction method of 3 to 10 μm, and a primary particle size calculated from the specific surface area of 10 to 50 nm, and the amount of the silica, relative to the resin solid fraction of the matte coating composition, is from 20 to 30% by weight.

### CROSS-REFERENCE TO RELATED APPLICATION

This application claims benefit of priority under 35 USC 119 based on prior Japanese Patent Application 2016-156582, filed by the same Applicant on Aug. 9, 2016, the entire contents of which are incorporated by reference herein.

### BACKGROUND OF THE INVENTION

### 1. Field of the Invention

An embodiment of the present invention relates to a matte coating composition used for forming a surface protective layer of a decorative material, and relates particularly to a matte coating composition which, due to the gloss difference from a high-gloss coating composition, can kiln′ a surface protective layer having an uneven three-dimensional feel. Other embodiments of the present invention relate to a decorative material that uses a cured coating film of the matte coating composition, and a method for producing the same.

### 2. Description of the Related Art

Generally, surface protective layers formed from curable coating materials are provided on the surfaces of substrates to impart the substrate with various resistance properties such as contamination resistance and chemical resistance, and also to provide an aesthetic design. These coating materials are designed in accordance with all manner of different applications, including packaging, optical products and interior construction materials. In the case of packaging and interior construction materials, a printed layer is provided on the substrate surface to create an aesthetic design.

For example, a paper container containing an item such as a commodity item may be printed with a pattern using multiple colors in order to attract the attention of purchasers, and a surface protective layer is then provided on the surface of the container. In recent years, there has been a trend to further enhance the design aesthetics by imparting a three-dimensional feel to the above pattern, thereby distinguishing the item from other products. Similarly, in the field of decorative materials, various methods have been proposed for forming three-dimensional uneven patterns on surfaces in order to enhance the design aesthetics. However, the actual formation of a printed layer having an uneven form on the surface of a decorative material has significant restrictions from a practical perspective.

On the other hand, instead of a method of actually forming a printed layer having the desired uneven form on the surface of a decorative material, a method for portraying an uneven shape by a visual effect that utilizes an optical illusion to the human eye is also known. Specifically, this method provides a high-gloss portion and a low-gloss portion within the surface protective layer, thereby portraying an uneven three-dimensional feel due to an optical illusion arising from the gloss difference (see JP 2000-043223 A). In order to generate an uneven three-dimensional feel using this method, the gloss difference between the high-gloss portion and the low-gloss portion is very important. The uneven three-dimensional feel can be enhanced relatively easily by increasing this gloss difference.

Typical resins for inclusion in these coating materials are transparent and have high gloss. Accordingly, by forming a coating material having lower gloss than these typical transparent coatings, an uneven three-dimensional feel can be portrayed by generating a gloss difference between the two coating materials. Generally, a low-gloss coating material with a matting effect can be obtained by adding a gloss modifier such as a filler to a transparent coating material.

However, the low-gloss coating materials described above tend to become increasingly prone to whitening of the coating film as the amount of filler added is increased, and the transparency of the coating film tends to deteriorate. If the transparency of the coating film deteriorates, then the pattern on the printed layer becomes less distinct, and the design aesthetics of the overall decorative material deteriorate. Further, the amount of filler added also affects the coating film properties, and may sometimes cause a deterioration in the resistance properties such as the contamination resistance and the chemical resistance. Accordingly, matte coating compositions for forming surface protective layers must not only have low gloss, but also provide satisfactory levels of various resistance properties and transparency.

### SUMMARY OF THE INVENTION

In light of these circumstances, an object of one embodiment of the present invention is to provide a matte coating composition which, while exhibiting low gloss, has high levels of transparency and various resistance properties. Further, objects of other embodiments of the present invention are to provide a decorative material having superior design aesthetics that uses the above matte coating composition, and a method for producing the decorative material.

Embodiments of the present invention are described below, but the invention is not limited to these embodiments.

One embodiment relates to a matte coating composition, which can be used favorably in a decorative material having, in order, a substrate, a printed ink layer, a first surface protective layer formed from a cured coating film of the matte coating composition, and a second surface protective layer that is provided partially covering the first surface protective layer and has a higher gloss than the first surface protective layer. The matte coating composition contains a silica and a binder component, and is at least one of heat-curable and ionizing radiation-curable,

the silica has an average particle size determined by a laser diffraction method of 3 to 10 μm, and a primary particle size calculated from the specific surface area of 10 to 50 nm, and

the amount of the silica, relative to the resin solid fraction of the matte coating composition, is from 20 to 30% by weight.

In the matte coating composition described above, the binder component preferably contains a heat-curable resin containing an acrylic polyol and a polyester polyol, and an isocyanate curing agent.

The acrylic polyol preferably has a weight-average molecular weight of 10,000 to 50,000, and a hydroxyl value of 50 to 200 mgKOH/g.

The isocyanate curing agent preferably contains one or more compounds selected from the group consisting of hexamethylene diisocyanate, toluene diisocyanate, xylylene diisocyanate, isophorone diisocyanate, and derivatives of these compounds.

In the matte coating composition described above, the binder component preferably contains an ionizing radiation-curable resin containing a polyfunctional (meth)acrylate.

Another embodiment relates to a decorative material having, in order, a substrate, a printed ink layer, a first surface protective layer, and a second surface protective layer provided partially covering the first surface protective layer. In this decorative material, the first surface protective layer is formed from a cured coating film of a matte coating composition, and the second surface protective layer is formed from a cured coating film of a coating composition having a higher gloss than the first surface protective layer,

the matte coating composition contains a silica and a binder component, and is at least one of heat-curable and ionizing radiation-curable,

the silica has an average particle size determined by a laser diffraction method of 3 to 10 μm, and a primary particle size calculated from the specific surface area of 10 to 50 nm,

the amount of the silica, relative to the resin solid fraction of the matte coating composition, is from 20 to 30% by weight, and

the specular glossiness of the first surface protective layer at an incident angle of 60° is 5 or less.

In the decorative material described above, the substrate is preferably a paper. The first surface protective layer preferably has a thickness of 2 to 10 μm.

In the decorative material described above, the coating composition used for forming the second surface protective layer is preferably at least one of heat-curable and ionizing radiation-curable. Further, the coating composition preferably contains an ionizing radiation-curable resin containing a polyfunctional (meth)acrylate.

In the decorative material described above, the specular glossiness of the second surface protective layer at an incident angle of 60° is preferably at least twice as large as the specular glossiness of the first surface protective layer at an incident angle of 60°.

Yet another embodiment relates to a method for producing a decorative material having, in order, a substrate, a printed ink layer, a first surface protective layer formed from a cured coating film of a matte coating composition, and a second surface protective layer that is provided partially covering the first surface protective layer and has a higher gloss than the first surface protective layer, the method including:

(a) a step of forming a printed ink layer by applying an ink composition to a substrate,

(b) a step of forming a first surface protective layer by applying the matte coating composition of an embodiment of the present invention to the entire upper surface of the printed ink layer, and then curing the matte coating composition, and

(c) a step of forming a second surface protective layer by applying a coating composition that is at least one of heat-curable and ionizing radiation-curable so as to partially cover the upper surface of the first surface protective layer, and then curing the coating composition.

In the above step (b), the matte coating composition is preferably both heat-curable and ionizing radiation-curable, with the curing performed by heating, and in the above step (c), the coating composition is preferably ionizing radiation-curable, with the curing performed by irradiation with ionizing radiation.

In the above step (b), the matte coating composition is preferably heat-curable, with the curing performed by heating, and in the above step (c), the coating composition is preferably heat-curable, with the curing performed by heating.

An embodiment of the present invention can provide a matte coating composition which, while exhibiting low gloss, has high levels of transparency and various resistance properties. Further, other embodiments can provide a decorative material having superior design aesthetics that uses the matte coating composition, and a method for producing the decorative material.

### BRIEF DESCRIPTION OF THE DRAWINGS

FIG. 1 is a schematic cross-sectional view illustrating a structural example of a decorative material according to an embodiment of the present invention.

### DESCRIPTION OF THE EMBODIMENTS

Embodiments of the present invention are described below in detail.

### (Matte Coating Composition)

In one embodiment of the present invention, a matte coating composition contains a silica and a binder component, and is at least one of heat-curable and ionizing radiation-curable, the silica has an average particle size determined by a laser diffraction method of 1 to 10 μm and a primary particle size calculated from the specific surface area of 10 to 50 nm, and the amount of the silica, relative to the resin solid fraction of the matte coating composition, is from 20 to 30% by weight.

The matte coating composition has low gloss and excellent transparency. As a result, when the matte coating composition is used to form a surface protective layer for a decorative material, the matting effect of the composition is able to impart the surface of the decorative material with a matte feel.

In a decorative material of a particularly preferred embodiment having, in order, a substrate, a printed ink layer, a first surface protective layer, and a second surface protective layer that is provided partially covering the first surface protective layer and has a higher gloss than the first surface protective layer, the matte coating composition described above can be used for forming the first surface protective layer. In this embodiment, by combining the matte coating composition with a coating composition having a higher gloss, a surface protective layer with superior design aesthetics, having a low-gloss portion and a high-gloss portion, can be provided.

This “low-gloss portion” means the portion formed from a cured coating film of the matte coating composition described above, whereas the “high-gloss portion” means the portion formed from a cured coating film of the aforementioned coating composition having a higher gloss. Further, the terms “high” and “low” used in relation to the gloss indicate the relative gloss of the matte coating composition or the coating composition compared with the other composition.

In the surface protective layer having a low-gloss portion and a high-gloss portion, in order to portray the unevenness in a three-dimensional manner, the gloss difference between the low-gloss portion and the high-gloss portion is preferably large. In this regard, when the matte coating composition described above is used to form the low-gloss portion of the surface protective layer, ensuring a large gloss difference from the high-gloss portion is relatively simple. Accordingly, in the above embodiment, the matte coating composition is able to impart the decorative material with an uneven three-dimensional feel, thereby enhancing the design aesthetics.

### (Silica)

The matte coating composition described above contains a silica having an average particle size determined by a laser diffraction method of 1 to 10 μm, and a primary particle size calculated from the specific surface area of 10 to 50 nm. The average particle size determined by a laser diffraction method is more preferably from 2 to 7 μm, and even more preferably from 3 to 6 μm. Further, the primary particle size of the silica is more preferably from 10 to 30 nm, and even more preferably from 15 to 25 nm. In one embodiment, it is preferable that the matte coating composition described above contains a silica having an average particle size determined by a laser diffraction method of 3 to 10 μm, and having a primary particle size calculated from the specific surface area of 10 to 50 nm. In one embodiment, an ultraviolet-curable resin is preferred.

The “average particle size determined by a laser diffraction method” means the average particle size calculated from a particle size distribution, wherein the particle size distribution is obtained by irradiating a laser light onto a liquid sample containing the silica particles dispersed in the liquid and then measuring the change in the Intensity of the light with the angle that is scattered as the laser light passes through the liquid.

Further, the “primary particle size” means a value calculated from the specific surface area of the silica using the formula [1] below.

Particle size d (nm)=6,000/specific surface area S (m²/g)·density ρ (g/cm³) [Formula 1]

In the matte coating composition described above, when a silica having an average particle size exceeding 1 μm is used, reducing the gloss of the cured coating film surface by forming unevenness on the cured coating film surface is relatively easy. Further, when a silica having an average particle size of 10 μm or less is used, retaining the silica within the cured coating film is easier. Further, when a silica having a primary particle size exceeding 10 nm is used, reducing the gloss of the cured coating film surface by forming fine unevenness on the cured coating film surface is relatively easy.

When a silica having a primary particle size of 50 nm or less is used, suppressing scattering and improving the transparency is easier. In this manner, the average particle size of the silica affects the matting effect, whereas the primary particle size of the silica tends to affect the transparency of the coating film. Accordingly, in the present invention, it is thought that by using a silica having an average particle size within a prescribed range and also having a primary particle size within to prescribed range (hereafter referred to as the silica (A) to differentiate it from other silicas), a matte coating composition having low gloss while also having excellent transparency can be obtained.

A multitude of different silicas are known as gloss modifiers, and generally, as the amount of silica is increased in order to reduce the gloss of the coating composition, the transparency of the coating film tends to deteriorate. It is thought that this deterioration in transparency is because increasing unevenness is formed on the coating film surface as the amount of silica is increased, with this unevenness causing light scattering. In other words, low gloss and transparency usually exist in a trade-off type relationship. However, the inventors of the present invention discovered that when the silica (A) having the specific combination of particle sizes described above was used, a combination of low gloss and good transparency could be achieved within a certain range. Although not bound by theory, it is surmised that within this prescribed range, very fine unevenness is formed on the coating film surface by the silica primary particles, and at this very fine uneven surface, light is not scattered, but rather undergoes mainly Rayleigh scattering, enabling the transparency to be maintained.

The silica (A) used in the above matte coating composition need only have the combination of particle sizes described above, and there are no particular limitations on the shape of the particles. Commercially available silica powders produced by conventional methods can be used. Further, in those cases where the matte coating composition contains a solvent such as water or an organic solvent, colloidal silicas obtained by subjecting the silica particles to a dispersion treatment using any of various solvents as a dispersion medium can be used.

The dispersion medium of a colloidal silica may be a polar solvent or a non-polar solvent. Examples of the polar solvent include water, alcohols such as methanol, ethanol, isopropanol and n-butanol, polyhydric alcohols such as ethylene glycol and derivatives thereof, ketones such as methyl ethyl ketone, methyl isobutyl ketone and dimethylacetamide, and esters such as ethyl acetate. Examples of the non-polar solvent include toluene and xylene.

The silica (A) may be either a surface-treated silica or an untreated silica. Examples of treatment agents that may be used for the surface treatment include organic substances and/or inorganic substances, including silane coupling agents, microcrystalline wax and alumina. Although there are no particular limitations, from a cost perspective, an untreated silica is preferred. There are no particular limitations on the shape of the particles of the silica (A), provided that the particles have the average particle size prescribed above and the primary particle size prescribed above.

The amount of the silica (A), relative to the resin solid fraction of the matte coating composition, is within a range from 20 to 30% by weight. This amount is more preferably from 23 to 30% by weight, and even more preferably from 25 to 28% by weight. When the amount of the silica (A) is at least 20% by weight, satisfactory levels of design aesthetics, optical properties, and resistance properties such as abrasion resistance can be obtained relatively easily. In contrast, when the amount of the silica (A) is 30% by weight or less, any deterioration in the fluidity of the matte coating composition can be suppressed, and therefore good coatability can be easily achieved. Here, the “resin solid fraction” means the total of all the components that constitute the binder component described below, and more specifically means the total of all resin components such as heat-curable resins and/or ionizing radiation-curable resins, and any optionally used curing agent components.

The wettability (coating) of the silica by the resin affects the transparency of the coating film and the overall design aesthetics. For example, if a silica having unsatisfactory wettability is used, then light tends to scatter at the silica surface, resulting in a deterioration in the transparency of the coating film. If this type of coating film having inferior transparency is used as the first surface protective layer, and the second surface protective layer is then formed on top, then the overall transparency can be improved. However, in embodiments of the surface protective layers envisaged in the present invention, portions of the first surface protective layer are necessarily exposed. Accordingly, from a design perspective, the silica (A) preferably exhibits satisfactory wettability by the resin. In this regard, favorable wettability can be more easily obtained when the amount of the silica (A) is restricted to 30% by weight or less.

The matte coating composition contains the silica (A) described above as a gloss modifier. In one embodiment, the matte coating composition may also contain a silica other than the silica (A), and/or one or more other known gloss modifiers, in order to appropriately alter the gloss without impairing the transparency. Examples of other gloss modifiers that can be used include alumina, calcium carbonate, barium sulfate and resin beads.

### (Binder Component)

The matte coating composition can be classified based on the binder component used, which is at least one of heat-curable and ionizing radiation-curable. When the matte coating composition is used to form a surface protective layer for a decorative material, at least a portion of the coating film of the matte coating composition constitutes the outermost surface layer of the decorative material. The binder component is the main component of the coating film. Accordingly, the binder component preferably contains a curable resin, and the types of curable resins capable of forming a coating film having the required level of various surface properties such as abrasion resistance, scratch resistance, solvent resistance and contamination resistance are preferably combined as appropriate. The binder component may also contain a curing agent, depending on the nature of the curable resins used.

When a heat-curable resin is used as the binder component, a heat-curable matte coating composition can be formed. For example, the heat-curable resin may contain at least one resin selected from the group consisting of melamine-based resins, epoxy-based resins, acrylic-based resins (also called acrylic polymers), urethane-based resins, polyester-based resins and silicone-based resins.

Further, when an ionizing radiation-curable resin is used as the binder component, an ionizing radiation-curable matte coating composition can be formed. The term “ionizing radiation-curable resin” means a resin that cures upon irradiation with ionizing radiation such as ultraviolet radiation or an electron beam. In one embodiment, an ultraviolet-curable resin is preferred. For example, the ionizing radiation-curable resin may be an acrylic-based resin or an acrylic urethane-based resin. These resins may be used individually, or a combination of resins may be used.

Moreover, if required, a combination of a heat-curable resin and an ionizing radiation-curable resin may be used as the binder component. In this case, a hybrid matte coating composition that is both heat-curable and ionizing radiation-curable can be formed.

The binder component is described below in further detail.

### (Heat-Curable)

In one embodiment of a heat-curable matte coating composition, the binder component preferably contains a heat-curable resin containing a polyol compound, and an isocyanate curing agent. In this type of embodiment, reaction between the polyol compound and the isocyanate curing agent causes formation of a polyurethane polyol resin.

Examples of polyol compounds that can be used in the present invention include any compound having two or more hydroxyl groups within the molecule, and there are no particular limitations. Specific examples include hydroxyl group-containing acrylic resins, polyhydric alcohols, polyether polyols, polyester polyols, polycarbonate polyols and alkyd resins.

Examples of the hydroxyl group-containing acrylic resins (hereafter also called acrylic polyols) include polymers of a (meth)acrylic monomer having a hydroxyl group, and copolymers of a (meth)acrylic monomer having a hydroxyl group and another (meth)acrylic monomer.

The (meth)acrylic monomer having a hydroxyl group may be at least one compound selected from the group consisting of 2-hydroxyethyl (meth)acrylate, 1-hydroxpropyl (meth)acrylate, 2-hydroxypropyl (meth)acrylate, 4-hydroxybutyl (meth)acrylate, polyethylene glycol mono(meth)acrylate, polypropylene glycol mono(meth)acrylate, and polytetramethylene glycol mono(meth)acrylate.

Further, examples of the aforementioned other (meth)acrylate monomer that can be used to produce the acrylic polyol include alkyl (meth)acrylates. This alkyl (meth)acrylate may be at least one compound selected from the group consisting of methyl (meth)acrylate, ethyl (meth)acrylate, butyl (meth)acrylate, hexyl (meth)acrylate, 2-ethylhexyl (meth)acrylate, stearyl (meth)acrylate and lauryl (meth)acrylate.

Further, if required, an aromatic vinyl monomer may also be added as a monomer compound during the production of the aforementioned copolymer. Specific examples of this aromatic vinyl monomer include styrene, methylstyrene and ethylstyrene.

Other examples of the aforementioned other (meth)acrylic monomer include (meth)acrylic monomers having a functional group other than a hydroxyl group. For example, (meth)acrylic monomers having at least one functional group selected from the group consisting of a carboxyl group, amino group, epoxy group, N-alkoxyalkyl groups and N-methylol group can be used.

The acrylic polyol can be prepared in accordance with known methods. For example, the acrylic polyol can be obtained in a solvent or in water, using an ethylenic unsaturated monomer having a hydroxyl group as the essential monomer and using other monomer as required, by subjecting the monomers to radical polymerization or ionic polymerization.

In one embodiment, the acrylic polyol is preferably a copolymer obtained from a raw material monomer containing an ethylenic unsaturated monomer (I) having a hydroxyl group, and an alkyl (meth)acrylate (II) containing methyl methacrylate as another ethylenic unsaturated monomer. The raw material monomer may also contain another monomer (III) containing a styrene-based monomer and/or an ethylenic unsaturated monomer having a carboxyl group. In this raw material monomer that produces the aforementioned copolymer, relative to the total weight of all of the monomers (I) to (III), the proportion of the monomer (I) is preferably from 10 to 35% by weight, and the proportion of the monomer (II) is preferably from 30 to 65% by weight.

The weight-average molecular weight of the acrylic polyol is preferably within a range from 10,000 to 50,000, more preferably from 10,000 to 40,000, and even more preferably from 15,000 to 35,000.

Further, the hydroxyl value of the acrylic polyol is preferably not more than 200 mgKOH/g, and may be 0. More specifically, in one embodiment, the hydroxyl value is preferably within a range from 50 to 200 mgKOH/g, more preferably from 50 to 150 mgKOH/g, and even more preferably from 80 to 120 mgKOH/g. In another embodiment, the hydroxyl value is preferably 0.

Further, the acid value of the acrylic polyol is preferably not more than 20 mgKOH/g, and may be 0. More specifically, in one embodiment, the acid value is preferably within a range from 2 to 20 mgKOH/g, more preferably from 5 to 15 mgKOH/g, and even more preferably from 10 to 15 mgKOH/g. In another embodiment, the acid value of the acrylic polyol is preferably 0. In this case, the heat-curable resin in the binder component contains an acrylic polymer that is not an acrylic polyol.

Although not a particular limitation, in one embodiment, the binder component preferably contains an acrylic polyol having a weight-average molecular weight of 10,000 to 40,000, a hydroxyl value of 50 to 200 mgKOH/g and an acid value of 5 to 15 mgKOH/g. In another embodiment, the binder component preferably contains an acrylic polymer having a weight-average molecular weight of 10,000 to 40,000, a hydroxyl value of 50 to 200 mgKOH/g and an acid value of 0. When the acrylic polyol and/or the acrylic polymer described above is used, the printability and coatability of the matte coating composition, the strength of the cured coating film, and the adhesion to the printed ink layer all tend to improve. The embodiment using the acrylic polyol described above is particularly desirable.

Examples of the polyhydric alcohol compounds include 1,3-propanediol, 2-methyl-1,3-propanediol, 1,4-butanediol, 2-methyl-1,4-butanediol, 1,2-dimethyl-1,4-butanediol, 2-ethyl-1,4-butanediol, 1,5-pentanediol, 2-methyl-1,5-pentanediol, 3-methyl-1,5-pentanediol, 2,2,4-trimethyl-1,3-pentanediol, 3-ethyl-1,5-pentanediol, 1,6-hexanediol, 2-methyl-1,6-hexanediol, 3-methyl-1,6-hexanediol, 1,7-heptanediol, 2-methyl-1,7-heptanediol, 3-methyl-1,7-heptanediol, 4-methyl-1,7-heptanediol, 1,8-octanediol, 2-methyl-1,8-octanediol, 2-ethyl-1,8-octanediol, 3-methyl-1,8-octanediol, 4-methyl-1,8-octanediol, 1,9-nonanediol, ethylene glycol, propylene glycol, neopentyl glycol, diethylene glycol, dipropylene glycol, cyclohexanedimethanol, polyethylene glycol, polypropylene glycol, polytetramethylene glycol, trimethylolpropane, 1,1,1-trimethylolpropane ethylene glycol, glycerol, erythritol, xylitol, sorbitol and mannitol.

Examples of the polyether polyols include polyalkylene glycols such as polyethylene glycol, polypropylene glycol and polytetramethylene glycol, as well as ether compounds in which at least one of the terminal hydroxyl groups of these polyalkylene glycols has been modified with an amino group, carboxyl group, epoxy group, N-methylol group or N-alkoxymethyl group.

Examples of polyester polyols that can be used favorably include polyester polyols obtained by a condensation reaction of a polybasic acid (such as phthalic acid, isophthalic acid, terephthalic acid, tetrahydrophthalic acid, tetrachlorophthalic acid, tetrabromophthalic acid, hexahydrophthalic acid, himic acid, HET acid, succinic acid, maleic acid, fumaric acid, adipic acid, sebacic acid, dodecenylsuccinic acid, trimellitic acid or pyromellitic acid) or an anhydride thereof, and a polyhydric alcohol (such as ethylene glycol, diethylene glycol, propylene glycol, dipropylene glycol, glycerol, trimethylolpropane, 1,3-butanediol, 1,4-butanediol, 1,6-hexanediol, neopentyl glycol, 1,2,6-hexanetriol, pentaerythritol, sorbitol or bisphenol-A), polyester polyols obtained by a reaction between an aforementioned polyhydric alcohol, an epoxy compound (such as n-butyl glycidyl ether and allyl glycidyl ether) and an aforementioned polybasic acid, polyester polyols obtained by a reaction between an aforementioned epoxy compound and an aforementioned polybasic acid, alkyd-type polyols obtained by a reaction between a higher fatty acid (such as soybean oil, linseed oil, safflower oil, coconut oil, dehydrated castor oil, tung oil or rosin), an aforementioned polybasic acid and an aforementioned polyhydric alcohol, and polymerized polyester polyols obtained by a ring-opening polymerization of ε-caprolactam and an aforementioned polyhydric alcohol.

The polyester polyol used in the present invention can be obtained as a commercial product. Specific examples include products from Kuraray Co., Ltd., including Kuraray Polyol P-510, P-1010, P-1510, P-2010, P-3010, P-4010, P-5010, P-6010, P-2011, P-2013, P-520, P-1020, P-2020, P-1012, P-2012, P-530, P-1030, P-2030, PMHC-2050, PMHC-2050R, PMHC-2070, PMHC-2090, PMSA-1000, PMSA-2000, PMSA-3000, PMSA-4000, F-2010, F-3010, N-2010, PNOA-1010, PNOA-2014 and O-2010. Other examples include products from Sumika Bayer Urethane Co., Ltd., including Desmophen 650MPA, 651MPA/X, 670, 670BA, 680X, 680MPA, 800, 800MPA, 850, 1100, 1140, 1145, 1150, 1155, 1200, 1300X, 1652, 1700, 1800, RD181, RD181X and C200. Yet further examples include products from Toyobo Co., Ltd., including Vylon 200, 560, 600, GK130, GK860, GK870, 290, GK590, GK780 and GK790, and products from Sumika Bayer Urethane Co., Ltd. such as Desmophen 250U, 550U, 1600U, 1900U, 1915U and 1920D.

Modified products such as vinyl-modified polyester polyols and epoxy-modified polyesters may also be used as the polyester polyol. These modified products can also be obtained as commercial products. Specific examples include products from Tosoh Corporation such as Nippolan 134, 800 and 1100, products from Sumika Bayer Urethane Co., Ltd. such as Desmophen 670, 800, 1100, 1200 and 1700, and products from DIC Corporation such as Burnock 11-408, D-210-80, D161, J517 and D-128-65BA.

In one embodiment, among the various possible polyester polyols, a branched polyester polyol is particularly preferred. The weight-average molecular weight of the polyester polyol is preferably within a range from 400 to 1,000, more preferably from 400 to 800, and even more preferably from 400 to 600. The acid value is preferably within a range from 1 to 10 mgKOH/g, more preferably from 1 to 8 mgKOH/g, and even more preferably from 1 to 5 mgKOH/g. In another embodiment, the acid value may be 0. Further, the hydroxyl value is preferably within a range from 100 to 300 mgKOH/g, more preferably from 180 to 250 mgKOH/g.

Examples of the polycarbonate polyols include products from Kuraray Co. Ltd. such as Kuraray Polyol PMHC-590, PMHC-1050, PMHC-1050R, PMHC-1090, PMHC-2050, PMHC-2050R, PMHC-2070, PMHC-2070R, PMHC-2090, PMHC-2090R and PMHC-5090. Other examples include products from Asahi Kasei Corporation such as T4691, T5692, T4671, T4672, T5650E, T5650J, T5651 and T5652.

Alkyd resins are reaction products of a polyol, a fatty acid and/or a polybasic acid. Examples of polyols that can be used for forming an alkyd resin include at least one compound selected from the group consisting of ethylene glycol, diethylene glycol, triethylene glycol, trimethylolpropane and ditrimethylolpropane. Examples of fatty acids that can be used include at least one fatty acid selected from the group consisting of coconut oil, palm oil, olive oil and castor oil. Examples of polybasic acids that can be used include at least one compound selected from the group consisting of phthalic anhydride, isophthalic acid, terephthalic acid, succinic acid, adipic acid, maleic acid, maleic anhydride and fumaric acid.

In one embodiment, the weight-average molecular weight of the alkyd resin is preferably within a range from 6,000 to 12,000, more preferably from 7,000 to 10,000, and even more preferably from 8,000 to 10,000. The acid value is preferably within a range from 1 to 10 mgKOH/g, more preferably from 1 to 8 mgKOH/g, and even more preferably from 1 to 5 mgKOH/g. In another embodiment, the acid value may be 0. Further, the hydroxyl value is preferably within a range from 40 to 200 mgKOH/g, more preferably from 50 to 180 mgKOH/g, and even more preferably from 60 to 150 mgKOH/g.

In one embodiment, from the viewpoint of the durability of the cured coating film, it is preferable that among the various polyol compounds that can be used for the binder component, at least an acrylic polyol is used. Further, the use of a polyester polyol as the polyol compound is even more preferred. In those cases where a combination of an acrylic polyol and a polyester polyol is used as the polyol compound, improving the solvent resistance and transparency of the cured coating film is easier.

Accordingly, in one embodiment of the heat-curable matte coating composition, the binder component preferably contains a heat-curable resin containing an acrylic polyol and a polyester polyol, and an isocyanate curing agent. In another embodiment, the binder component preferably also contains an alkyd resin in addition to each of the components of the above embodiment. In this manner, an embodiment that combines an acrylic polyol with two or more other polyols (polyols other than acrylic polyols), and preferably with a polyester polyol and an alkyd resin, is particularly preferred because it makes it easier to adjust the printability including the pot life, as well as various physical properties of the cured coating film such as the solvent resistance and the specular glossiness.

### (Isocyanate Curing Agent)

In the binder component, there are no particular limitations on the isocyanate curing agent that is used in combination with the polyol compound described above. Both aliphatic isocyanates and aromatic isocyanates may be used. In one embodiment, the isocyanate preferably contains one or more compounds selected from the group consisting of hexamethylene diisocyanate (HDI), toluene diisocyanate (TDI), xylylene diisocyanate (XDI), isophorone diisocyanate (IPDI) and derivatives of these compounds.

Each of the above diisocyanates may have a substituent. The isocyanate curing agent may also be an aliphatic and/or aromatic polyisocyanate. Biurets and isocyanurates can also be used. Further, adducts or the like obtained by modifying an aforementioned aliphatic and/or aromatic polyisocyanate with trimethylolpropane can also be used. These embodiments are intended to be included within the scope of the derivatives mentioned above, and these derivatives are preferably isocyanurates and/or adducts of the compounds mentioned above.

In one embodiment, an HDI-based isocyanurate, a TDI-based adduct, or an XDI-based adduct is preferably used as the isocyanate curing agent. These types of compounds are available commercially. Examples include the product “Basonat HI100” (an HDI-based isocyanurate) manufactured by BASF Chemicals Co., Ltd., the product “Desmodur L75” (a TDI-based adduct) manufactured by Sumika Bayer Urethane Co., Ltd., and the product “Takenate D-110N” (an XDI-based adduct) manufactured by Mitsui Takeda Chemicals, Inc.

The amount added of the isocyanate curing agent is preferably adjusted as appropriate, with due consideration of the total number of reactive functional groups in the polyol compound. In one embodiment, the polyol compound in the binder component contains an acrylic polyol and a polyester polyol. In this case, the amount added of the isocyanate curing agent is preferably adjusted so as to provide 0.5 to 3 mol of the curing agent for each 1 mol of the total number of reactive functional groups in the acrylic polyol and the polyester polyol.

Here, the total number of reactive functional groups means the total of all the groups such as hydroxyl groups and carboxyl groups capable of reacting with the isocyanate group in the isocyanate curing agent. When the hydroxyl value and/or acid value of the acrylic polyol is 0, the isocyanate curing agent mainly undergoes a curing reaction with the polyester polyol. In one embodiment, the solid fraction weight ratio between the acrylic polyol and the polyester polyol is preferably within a range from acrylic polyol/polyester polyol=2/8 to 8/2, more preferably from 5/5 to 8/2.

In another embodiment, the polyol compound in the binder component contains three compounds, namely an acrylic polyol, a polyester polyol and an alkyd resin. In this case, the amount added of the isocyanate curing agent is preferably adjusted so as to provide 0.5 to 3 mol of the curing agent for each 1 mol of the total number of reactive functional groups in these three polyol compounds. In one embodiment, the solid fraction weight ratio represented by acrylic polyol/polyester polyol/alkyd is preferably within a range of (2 to 8)/(1 to 4)/(1 to 4).

### (Ionizing Radiation-Curable)

The term “ionizing radiation-curable” describes a resin that can be cured by radiation that exerts an ionizing action. Specific examples of the ionizing radiation include an electron beam (EB) and ultraviolet radiation (UV). In other words, in one embodiment, the binder component contains an electron beam-curable resin and/or an ultraviolet-curable resin, and preferably contains an ultraviolet-curable resin.

Accordingly, in one embodiment of the ionizing radiation-curable matte coating composition, the binder component contains an ultraviolet-curable resin and a photopolymerization initiator, and if required, may also contain other components such as an inert resin. A polymerizable oligomer and/or a polymerizable monomer can be used as the ultraviolet-curable resin.

The polymerizable oligomer mentioned above can impart durability and flexibility to the cured coating film. In one embodiment, from the viewpoints of durability and flexibility, the number-average molecular weight of the polymerizable oligomer is preferably at least 600, more preferably at least 700, and even more preferably 800 or greater. Generally, resins become more difficult to handle as the viscosity increases, and therefore the resin is typically diluted with a low-viscosity monomer or solvent. However, from the viewpoint of the formability of the cured coating film, a low-viscosity monomer can sometimes cause inferior physical properties. Further, when the amount of solvent added is increased to adjust the viscosity of the resin, the printability tends to worsen due to the reduction in the resin solid fraction within the varnish. Accordingly, from the viewpoints of viscosity control and handling, the number-average molecular weight of the above polymerizable oligomer is preferably not more than 10,000, more preferably not more than 5,000, and even more preferably 1,500 or less.

The number-average molecular weight mentioned above means a value measured by gel permeation chromatography (GPC). Specific examples of polymerizable oligomers that can be used in the present invention include urethane acrylates, polyester acrylates, acrylic acrylates and epoxy acrylates that also have a (meth)acrylate group. Among these polyfunctional (meth)acrylates, in terms of anticipating an improvement in adhesion to the substrate and enhanced flexibility, a urethane acrylate having a (meth)acrylate group is preferred. Further, it is even more preferable that the urethane acrylate is difunctional or higher. Here, the expression “difunctional or higher” means that two or more reactive sites at which curing can proceed upon irradiation with ionizing radiation (for example, ethylenic unsaturated bond sites) exist within a single molecule.

The polymerizable monomer mentioned above enables improvements in the physical properties of the cured coating film and adjustment of the viscosity of the matte coating composition. The polymerizable monomer is preferably a (meth)acrylate-based monomer having a radical-polymerizable unsaturated group within the molecule, and of these monomers, polyfunctional (meth)acrylates are particularly preferred.

A polyfunctional (meth)acrylate is a (meth)acrylate having two or more radical-ethylenic unsaturated bonds within the molecule. Although there are no particular limitations, specific examples of the polyfunctional (meth)acrylate include ethylene glycol di(meth)acrylate, propylene glycol di(meth)acrylate, 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylolpropane tri(meth)acrylate, ethylene oxide-modified trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl) isocyanurate, propionic acid-modified dipentaerythritol penta(meth)acrylate, dipentaerythritol hexa(meth)acrylate, ethylene oxide-modified dipentaerythritol hexa(meth)acrylate, caprolactone-modified dipentaerythritol hexa(meth)acrylate and ethylene oxide-modified bisphenol-A diacrylate. These polyfunctional (meth)acrylates may be used individually, or a combination of two or more polyfunctional (meth)acrylates may be used.

In one embodiment, among the polyfunctional (meth)acrylates described above, the use of at least one of pentaerythritol tetraacrylate and dipentaerythritol hexaacrylate is preferred. Using these compounds is preferred in terms of improving the physical properties of the film obtained following crosslinking (the cured coating film).

The binder component may also contain a monofunctional (meth)acrylate in addition to the polyfunctional (meth)acrylate described above. When a monofunctional (meth)acrylate is also used, the viscosity of the binder component can be reduced. The amount added of the monofunctional (meth)acrylate is preferably adjusted as appropriate so as not to impair the objects of the present invention.

Specific examples of the monofunctional (meth)acrylate include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, lauryl (meth)acrylate, stearyl (meth)acrylate and isobornyl (meth)acrylate. These monofunctional (meth)acrylates may be used individually, or a combination of two or more monofunctional (meth)acrylates may be used.

When an ultraviolet-curable resin is used as the binder component, a suitable photopolymerization initiator is preferably selected in accordance with the type of resin.

The polymerizable oligomers and polymerizable monomers listed above have a radical-polymerizable unsaturated group within the molecule. Examples of photopolymerization initiators that can be used to initiate polymerization of these types of radical-polymerizable compounds include compounds such as acetophenones, benzophenones, thioxanthones, aromatic diazonium salts and metallocene. In the polymerization reaction, the photopolymerization initiator may be used in combination with a polymerization accelerator and/or a sensitizer if required. Examples of compounds that can be used as polymerization accelerators include amines and phosphines. Further, examples of compounds that can be used as sensitizers include p-dimethylbenzoate esters, tertiary amines and thiol-based sensitizers. The amount added of the photopolymerization initiator is preferably adjusted with due consideration of the number of functional groups and the reactivity. In one embodiment, the amount added of the photopolymerization initiator is preferably from 0.5 to 5 parts by weight per 100 parts by weight of the ultraviolet-curable resin.

Specific examples of photopolymerization initiators that can be used in the embodiment described above include benzoin, benzoin methyl ether, benzoin ethyl ether, benzoin isopropyl ether, benzoin n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2(hydroxy-2-propyl) ketone, benzophenone, p-phenylbenzophenone, 4,4′-diethylaminobenzophenone, dichlorobenzophenone, 2-methylanthraquinone, 2-ethylanthraquinone, 2-tertiary-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal and acetophenone dimethyl ketal.

In another embodiment of the ionizing radiation-curable matte coating composition, the binder component contains an electron beam-curable resin, and if required, may also contain other components such as an inert resin. When an electron beam-curable resin is used as the binder component, a photopolymerization initiator is unnecessary, and stable curing properties can be achieved without using a photopolymerization initiator. Further, because electron beam-curable resins can be easily prepared in solventless form, they can be used particularly favorably from environmental and health perspectives.

The binder resin may also contain an inert resin in order to maintain good adhesion to the lower layer and good flexibility for the cured coating film. Examples of the inert resin include epoxy-based resins, acrylic-based resins, urethane-based resins, polyester-based resins, alkyd-based resins, fiber-based resins and silicone-based resins.

Examples have been provided above for the binder component for forming heat-curable and ionizing radiation-curable coating compositions, and these different binder components may also be combined to form a hybrid coating composition that is both heat-curable and ionizing radiation-curable. This hybridization of the curable resins makes it easier to adjust the strength of the cured coating film and the surface segregation of the silica.

The matte coating composition may also contain a solvent if required. Examples of solvents that can be used include at least one solvent selected from the group consisting of toluene, xylene, cyclohexane, ethyl acetate, butyl acetate, methyl ethyl ketone, methyl isobutyl ketone, cyclohexanone, acetone, methyl alcohol, ethyl alcohol, isopropyl alcohol and water. In one embodiment, when the matte coating composition contains a solvent, the solvent preferably contains no water (namely, is non-aqueous).

When the matte coating composition is used to form a surface protective layer, the resulting cured coating film must have sufficient transparency to at least enable the underlying printed layer to be seen. Accordingly, as a basic principle, the matte coating composition should contain no colorants such as pigments or the like. However, in one embodiment, the matte coating composition may contain a small amount of a colorant, provided the required transparency is not impaired. In addition, the matte coating composition may also contain one or more additives if required. Examples of additives that can be used include plasticizers, dispersants, surfactants, tackifiers, adhesion assistants, desiccants, fluidity modifiers, abrasion resistance improvers, ultraviolet absorbers, photostabilizers, infrared absorbers, leveling agents, antifoaming agents, fillers, crosslinking agents and polymerization inhibitors.

The matte coating composition can be prepared by uniformly mixing and dispersing prescribed amounts of the binder component containing an arbitrary combination of any of the various curable resins and curing agents, polymerizable monomers and/or oligomers and polymerization initiators, together with the silica (A), and any other optional components such as various additives. The cured coating film can then be formed by applying the matte coating composition to a substrate, and either heating and drying the composition or irradiating the composition with ionizing radiation.

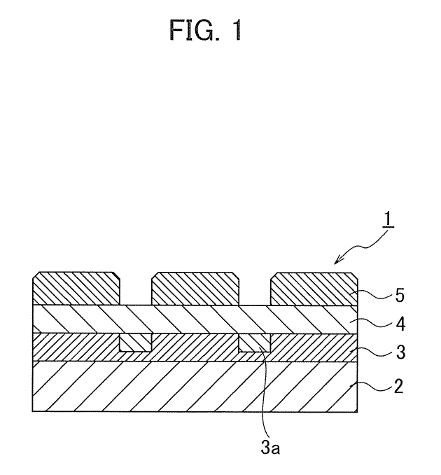

A second embodiment of the present invention relates to a decorative material. As illustrated in FIG. 1, a decorative material 1 according to this embodiment of the present invention has, in order, a substrate 2, a printed ink layer 3 having a printed pattern 3a, a first surface protective layer 4, and a second surface protective layer 5 that is provided partially covering the first surface protective layer 4, wherein the first surface protective layer 4 is formed from a cured coating film of the matte coating composition according to the first embodiment of the present invention. The second surface protective layer 5 is formed from a cured coating film of a coating composition having a higher gloss than the first surface protective layer.

In this embodiment, by using the first surface protective layer 4 to form a low-gloss portion and using the second surface protective layer 5 to form a high-gloss portion, the gloss difference between the two can be increased. As a result, an aesthetic design having an uneven three-dimensional feel can be achieved. In particular, it is preferable that the second surface protective layer 5 is provided in a manner that partially covers the first surface protective layer 4 so that, as illustrated in FIG. 1, the low-gloss first surface protective layer 4 is exposed in locations that correspond with the printed pattern 3a of the printed ink layer 3. For example, in those cases where the printed ink layer has a woodgrain-like printed pattern, an aesthetic design with a three-dimensional feeling that matches the woodgrain can be provided.

### (Substrate)

There are no particular limitations on the material of the aforementioned substrate, and for example, substrates formed from a paper and/or a resin may be used. In one embodiment, a paper substrate is preferred. The paper substrate preferably contains at least one type of paper selected from the group consisting of thin papers, craft papers, titanium papers, coated papers, resin-impregnated papers, flame-retardant papers and inorganic papers.

In addition to the above, the substrate may also be a film or sheet formed from any of various thermoplastic resins. Specific examples include films formed from polyethylene terephthalate, polypropylene or triacetyl acetate. Additional examples include sheets forming from resins selected from the group consisting of acrylic resins, vinyl chloride resins, styrene resins, polycarbonate resins, polyester resins, polyolefin-based resins, and ABS resins such as acrylonitrile-styrene-butadiene copolymers.

Although there are no particular limitations on the thickness of the substrate, in the case of a paper substrate, the basis weight is typically within a range from 20 to 150 g/m², and preferably from 30 to 100 g/m². On the other hand, in the case of a resin sheet substrate, the thickness is typically within a range from 20 to 200 μm, and preferably from 30 to 180 μm.

### (Printed Ink Layer)

The printed ink layer provides a decorative layer on the substrate, and is formed by printing an ink onto the substrate. Generally, a printing method such as gravure printing, offset printing, silk-screen printing or transfer printing from a transfer sheet can be used. There are no particular limitations on the constituent materials of the ink. A representative example of an ink that can be used contains an appropriate resin binder, a colorant such as a pigment and/or a dye, an extender pigment, a solvent and any of various additives, and these components are mixed uniformly together prior to use.

The resin binder in the ink may be any of various synthetic resins. Specific examples include acrylic-based resins, styrene-based resins, polyester-based resins, alkyd resins, urethane-based resins, polyvinyl-based resins, petroleum-based resins, epoxy-based resins, melamine-based resins, fluororesins, silicone-based resins and fiber-based resins. These resins may be used individually, or a combination of two or more resins may be used. In the case where a combination of two or more resins is used, either a mixture or a copolymer or the like may be used.

In one embodiment, the printed ink layer is preferably formed from an ink containing a fiber-based resin using a gravure printing method. Specific examples of the fiber-based resin include nitrocellulose-based resins and cellulose acetate-based resins.

The colorant may be a pigment and/or a dye. Specific examples include inorganic pigments such as carbon black, titanium white, zinc white, red iron oxide, chrome yellow, iron blue and cadmium red, as well as organic pigments or dyes such as azo pigments, lake pigments, anthraquinone pigments phthalocyanine pigments, isoindolinone pigments and dioxazine pigments. These colorants may be used individually, or a mixture containing a combination of two or more colorants may be used.

Specific examples of the solvent include toluene, xylene, cyclohexane, ethyl acetate, butyl acetate, methyl ethyl ketone, methyl isobutyl ketone, cyclohexanone, acetone, methyl alcohol, ethyl alcohol, isopropyl alcohol and water. These solvents may be used individually, or a combination of two or more solvents may be used.

If required, the ink may also contain an extender pigment such as calcium carbonate or barium sulfate. Further, the ink may also contain various additives such as plasticizers, dispersants, surfactants, tackifiers, adhesion assistants, desiccants, curing agents and curing accelerators.

### (First Surface Protective Layer)

In an embodiment of the present invention, the first surface protective layer is formed from a cured coating film of the matte coating composition of the first embodiment of the present invention, and is a low-gloss layer having high transparency.

The degree of low gloss can be determined, for example, by using the specular glossiness (at an incident angle of 60°) as an indicator. The lower the specular glossiness of the first surface protective layer, the greater the gloss difference between the low-gloss portion formed from the first surface protective layer and the high-gloss portion formed from the second surface protective layer, and the easier it becomes to portray an effective three-dimensional feel.

For these reasons, in one embodiment, the specular glossiness of the first surface protective layer is preferably 5 or less, and even more preferably 1 or less. Here, the specular glossiness can be measured in accordance with JIS8741 (1997), for example using a BYK-Gardner micro-gloss gloss meter manufactured by Toyo Seiki Seisaku-sho, Ltd. The specular glossiness is dependent mainly on the composition of the cured coating film, but also varies depending on the type of the substrate and the printed ink layer, and the thickness and the like of the cured coating film. Accordingly, the desired specular glossiness can be obtained relatively easily by designing these factors appropriately. For example, the printed ink layer is preferably a dark color such as black rather than a light color. Further, in terms of the substrate, a paper substrate makes it easier to obtain a low specular glossiness than a resin substrate.

The degree of transparency can be determined, for example, by using the lightness as an indicator. Here, the lightness means the value of L* in the L*a*b* color space upon measurement of the cured coating film obtained by applying the matte coating composition to a black ink and curing the composition. Measurement of the lightness can be made in accordance with JIS8781-4 (2013), for example using a spectral densitometer manufactured by X-Rite, Inc. In one embodiment, the lightness (L* value) of the first surface protective layer is preferably not more than 26, more preferably not more than 23, and even more preferably 20 or less. When a matte coating composition that forms a cured coating film having a lightness (L* value) of 26 or less is used for forming the first surface protective layer, the clarity of the printed pattern in the printed ink layer improves, resulting in better design aesthetics.

In an embodiment of the present invention, the silica (A) has an average particle size of 1 to 10 μm. As a result, the thickness of the coating film of the first surface protective layer is preferably adjusted so as not to greatly exceed the average particle size of the silica (A). If the thickness of the coating film is too large relative to the average particle size of the silica (A), then the silica (A) is more likely to become embedded in the coating film, which tends to cause a deterioration in the matting effect. In contrast, if the thickness of the coating film is too thin relative to the average particle size of the silica (A), then the silica (A) cannot be stably secured within the cured coating film, and the abrasion resistance tends to be more likely to deteriorate. From these types of viewpoints, in one embodiment, the thickness of the first surface protective layer is preferably within a range from 1 to 15 μm, more preferably from 1 to 10 μm, and even more preferably from 3 to 8 μm.

### (Second Surface Protective Layer)

The second surface protective layer is formed from a cured coating film of a coating composition. The second surface protective layer must be formed partially covering the first surface protective layer, with the gloss difference between the first surface protective layer and the second surface protective layer producing an aesthetic design and a three-dimensional feel. The coating composition is applied using a similar printing or coating method to that used for applying the matte coating composition to form the first surface protective layer described above. Further, in terms of the constituent materials of the coating composition, these materials preferably have similar transparency and surface properties to those of the matte coating composition described above. Accordingly, in one embodiment, the coating composition preferably contains a heat-curable resin and/or ionizing radiation-curable resin similar to the binder component of the matte coating composition.

In one embodiment, the coating composition preferably contains a heat-curable resin containing a polyol compound and an isocyanate curing agent as the binder component. In another embodiment, the coating composition preferably contains a urethane (meth)acrylate as the binder component.

In one embodiment, the coating composition may also contain a silica (B) if required. The gloss of the second surface protective layer effects the gloss of the entire decorative material. Accordingly, the silica (B) is preferably added to the coating composition in accordance with the design (printed pattern) of the decorative material to adjust the gloss of the second surface protective layer. When the silica (B) is added to the coating composition, not only can the gloss of the cured coating film be altered, but the resistance properties such as the abrasion resistance and scratch resistance can also be more easily improved.

There are no particular limitations on the types of silica that can be used as the silica (B), but the silica is selected so that the gloss is higher than that of the first surface protective layer. In one embodiment, the same silica as the silica (A) used in the matte coating composition used for forming the first surface protective layer may be used. In other words, in terms of the abrasion resistance and matting effects, a silica having an average particle size determined by a laser diffraction method of 1 to 10 μm can be used, but there are no particular limitations on the primary particle size or the particle shape of the silica. The silica (A) and the silica (B) can even employ silicas having the same surface treatment, the same average particle size and the same primary particle size. The average particle size of the silica (B) means the value measured using the same method as that described for the silica (A). In this type of embodiment, the gloss difference can be generated by altering the amounts added of the silica and the thickness of each of the layers.

In those cases where the silica (B) is added to the coating composition, the amount added is preferably not more than 20% by weight, and more preferably from 1 to 15% by weight, relative to the resin solid fraction of the coating composition. If the amount added of the silica (B) exceeds 20% by weight, then the composition becomes too similar to that of the cured coating film of the matte coating composition (the first surface protective layer), and even if the thicknesses of the respective coating films are altered, achieving a gloss difference on stacking of the layers tends to be difficult. From this viewpoint, the amount of the silica (B) in the coating composition is preferably lower than the amount of the silica (A) in the matte coating composition. As a result, the effect on the coating film transparency is minimal, and satisfactory transparency can be achieved even if no restrictions are placed on the primary particle size. On the other hand, in those cases where addition of the silica (A) to the matte coating composition used for forming the first surface protective layer is sufficient to generate a satisfactory gloss difference with the second surface protective layer, the coating composition need not necessarily contain the silica (B).

The second surface protective layer is applied partially covering the first surface protective layer, and the larger the coating amount, the easier a high-gloss finish can be achieved. Accordingly, in one embodiment, the gloss difference can be enhanced by adjusting the thickness of the second surface protective layer. For example, particularly in those cases where the compositions of the matte coating composition that forms the first surface protective layer and the coating composition that forms the second surface protective layer are similar, an effective gloss difference can be generated by increasing the coating amount of the coating composition that forms the second surface protective layer and making the thickness of the second surface protective layer greater than that of the first surface protective layer. Moreover, in order to achieve an even more effective three-dimensional feel, the coating amount of the coating composition may be altered so as to match the pattern (printed pattern) of the printed ink layer, thereby further enhancing the three-dimensional design aesthetics.

In a similar manner to the matte coating composition for forming the first surface protective layer, the coating composition for forming the second surface protective layer can be prepared by uniformly mixing and dispersing prescribed amounts of the binder component, the silica (B), and any of various additives as required. The second surface protective layer can then be obtained by applying the obtained coating composition so as to partially cover the first surface protective layer that has been applied using the method described above, and then curing the coating composition, either by heat curing by heating and drying, or by irradiation with ionizing radiation.

From the viewpoints of enhancing the three-dimensional and visual effects, and imparting the decorative material with excellent design aesthetics, the gloss difference between the first surface protective layer and the second surface protective layer is preferably large. Accordingly, it is desirable that the gloss of the second surface protective layer is considerably higher than that of the first surface protective layer.

In one embodiment, the specular glossiness of the second surface protective layer is preferably at least twice, and more preferably 3 times or more, as large as the specular glossiness of the first surface protective layer. More specifically, the specular glossiness of the second surface protective layer, measured using a gloss meter at an incident angle of 60°, is preferably at least 5, and more preferably 7 or greater. When the specular glossiness of the second surface protective layer is at least 5, the gloss difference between the low-gloss portion and the high-gloss portion is marked when the second surface protective layer is formed partially covering the first surface protective layer, making it easier to obtain a three-dimensional visual effect.

This three-dimensional visual effect is also related to the pattern (printed pattern), the print density and the color tone, as well as the synchronism between the printed ink layer and the surface protective layers. Accordingly, it is preferable that the amounts of silica added to the matte coating composition that forms the first surface protective layer and the coating composition that forms the second surface protective layer, and the thickness and the like of the surface protective layer formed from each composition are adjusted and synchronized as appropriate with due consideration of the properties of the printed ink layer.

In a preferred embodiment, the decorative material has a paper substrate, a dark-colored printed ink layer, the first surface protective layer formed from a cured coating film of the matte coating composition according to an embodiment of the present invention, and the second surface protective layer, wherein the specular glossiness of the first surface protective layer is 1 or less.

The dark-colored printed ink layer is preferably formed using a black ink. Further, the matte coating composition contains a silica having an average particle size of 3 to 6 μm and a primary particle size of 15 to 25 nm. Furthermore, the matte coating composition contains a binder component including an acrylic polyol having a weight-average molecular weight of 10,000 to 50,000 and a hydroxyl value of 50 to 200 mgKOH/g, a polyester polyol having a weight-average molecular weight of 400 to 1,000, an alkyd resin having a weight-average molecular weight of 6,000 to 12,000, and a difunctional or higher isocyanate curing agent. In one embodiment, the proportions of the various constituent components of the binder resin satisfy acrylic polyol/polyester polyol/alkyd resin=(2 to 8)/(1 to 4)/(1 to 4). The amount of the silica in the matte coating composition is from 20 to 30% by weight relative to the resin solid fraction of the matte coating composition.

In the embodiment described above, the thickness of the first surface protective layer is from 3 to 8 μm. On the other hand, the coating composition for forming the second surface protective layer contains a binder component including an acrylic polyol and an isocyanate curing agent, and a silica having an average particle size of 1 to 10 μm. The amount of the silica in the coating composition is from 1 to 15% by weight. The thickness of the second surface protective layer is from 2 to 15 μm.

### (Method for Producing Decorative Material)

A third embodiment of the present invention relates to a method for producing a decorative material. The method for producing a decorative material according to this embodiment of the present invention is a method for producing a decorative material having, in order, a substrate, a printed ink layer, a first surface protective layer formed from a cured coating film of a matte coating composition, and a second surface protective layer that is provided partially covering the first surface protective layer and has a higher gloss than the first surface protective layer, wherein the method includes steps (a) to (c) described below.

Step (a): forming a printed ink layer by applying an ink composition to a substrate.

Step (b): forming a first surface protective layer by applying the matte coating composition according to the first embodiment of the present invention to the entire upper surface of the printed ink layer obtained in step (a), and then curing the matte coating composition.

Step (c): forming a second surface protective layer by applying a coating composition that is at least one of heat-curable and ionizing radiation-curable so as to partially cover the upper surface of the first surface protective layer obtained in step (b), and then curing the coating composition.

In the steps (a) to (c), there are no particular limitations on the methods used for applying the ink composition and each of the coating compositions. Typically, a known printing method such as a gravure printing method, offset printing method, screen printing method or inkjet printing method can be used. Other methods that may also be used include roll coating methods, knife coating methods, a die coating methods, as well as other conventionally known coating methods. In one embodiment, when a gravure printing device is used for executing step (b) and step (c), the printing speeds for the matte coating composition and the coating composition are each preferably within a range from 30 to 120 m/minute, and more preferably from 60 to 100 m/minute. In those cases where the matte coating composition and/or the coating composition are heat-curable, the drying temperature is preferably within a range from 80 to 200° C., and more preferably from 130 to 180° C.

The combination of the matte coating composition used for forming the first surface protective layer and the coating composition used for forming the second surface protective layer is arbitrary. Examples of possible configurations include those listed below.

### <Configuration 1>

Substrate/printed ink layer/first surface protective layer (ionizing radiation-curable)/second surface protective layer (ionizing radiation-curable)

### <Configuration 2>

Substrate/printed ink layer/first surface protective layer (heat-curable)/second surface protective layer (ionizing radiation-curable)

### <Configuration 3>

Substrate/printed ink layer/first surface protective layer (heat-curable)/second surface protective layer (heat-curable)

### <Configuration 4>

Substrate/printed ink layer/first surface protective layer (ionizing radiation-curable)/second surface protective layer (heat-curable)

In addition, configurations in which each of the first surface protective layer and the second surface protective layer may be formed using a hybrid coating composition that is both heat-curable and ionizing radiation-curable are also possible. This type of hybridization enables an increase in the strength of the cured coating film, and enables better control of the surface segregation of the silica. Although not a particular limitation, preferred embodiments include the aforementioned configurations 1 to 3, and a configuration in which the first surface protective layer is formed using a heat-curable/ionizing radiation-curable hybrid composition and the second surface protective layer is formed using an ionizing radiation-curable composition. Among these, the last configuration is particularly preferred.

From the viewpoints mentioned above, in one embodiment, it is preferable that the matte coating composition used in step (b) is heat-curable and ionizing radiation-curable, namely is a hybrid composition. On the other hand, the coating composition used in step (c) is preferably an ionizing radiation-curable composition. In this type of embodiment, it is preferable that the curing in step (b) is performed by heating, and the curing in step (c) is performed by irradiation with ionizing radiation. Examples of the ionizing radiation include ultraviolet radiation (UV) and an electron beam (EB). In the case of curing with ultraviolet radiation, a high-pressure mercury lamp or a metal halide lamp can be used. A representative exposure dose is from 100 to 250 mJ/cm². Curing with an electron beam uses an electron beam irradiation device, and can be achieved, for example, by electron beam irradiation under conditions including an accelerating voltage of 80 to 150 kV and an irradiation dose of 20 to 50 kGy. By using these methods, satisfactory crosslinking of the resins can be achieved with relative ease, while degradation of the substrate is suppressed to a minimum.

In another embodiment, the matte coating composition used in step (b) is preferably heat-curable. On the other hand, the coating composition used in step (c) is preferably also heat-curable. In this type of embodiment, it is preferable that the curing in step (b) is performed by heating, and the curing in step (c) is also performed by heating. The curing by heating is typically performed by heating and drying at 80 to 180° C., and then aging at 40 to 70° C. across 1 to 2 days.

### EXAMPLES

The present invention is described below in further detail using a series of examples, but the following examples in no way limit the scope of the present invention. In the examples, “parts” represents “parts by weight”.

### 1. Preparation of Binder Components (Acrylic Polymers)

The acrylic polymers used in the examples were prepared in the following manner.

### Synthesis Example 1

A four-neck flask fitted with a condenser, a stirrer and a the iometer was charged with 1.6 parts of acrylic acid, 14.4 parts of methyl methacrylate, 20 parts of styrene, 4 parts of 2-hydroxyethyl methacrylate, 60 parts of butyl methacrylate and 200 parts of methyl ethyl ketone (MEK). The temperature was raised to 80° C. while the components in the flask were stirred under a stream of nitrogen, 2.0 parts of azobisisobutyronitrile was added, and a polymerization reaction was conducted over 3 hours. In this manner, an acrylic polymer (1) with a solid fraction of 33% having a hydroxyl value of 17.2 mgKOH/g, an acid value of 12.5 mgKOH/g and a weight-average molecular weight of about 30,000 was obtained.

### Synthesis Examples 2 to 9

With the exception of changing the blend ratio between the components from Synthesis Example 1 to the blend ratios illustrated in Table 1, a series of acrylic polymers was prepared in the same manner as that described for Synthesis Example 1. The hydroxyl values, acid values, weight-average molecular weights and solid fractions of the acrylic polymers (2) to (9) obtained in Synthesis Examples 2 to 9 are shown in Table 1. The acrylic polymers (2) to (8) correspond with acrylic polyols.

The weight-average molecular weight, acid value and hydroxyl value of each of the acrylic polymers prepared in Synthesis Examples 1 to 9 were measured in the manner described below.

### <Weight-Average Molecular Weight>

Measurement of the weight-average molecular weight was conducted using a GPC (gel permeation chromatography) system “Shodex GPC System-21” manufactured by Showa Denko K.K. GPC is a liquid chromatography technique that separates and quantifies substances dissolved in a solvent based on differences in molecular size. Tetrahydrofuran was used as the solvent, and determination of the molecular weight was made by comparison with standard polystyrenes.

### <Acid Value>

About 1 g of the sample (each of the acrylic polymers) was weighed accurately into a stoppered conical flask, and 100 ml of a mixed solvent of toluene and ethanol (volumetric ratio: toluene/ethanol=2/1) was added to dissolve the sample. A phenolphthalein reagent was added to the solution as an indicator, and after letting the solution stand for 30 seconds, a titration was performed with a 0.1 N alcoholic solution of potassium hydroxide until the solution developed a faint pink color. The acid value (mgKOH/g) for the dried-state resin was calculated using the following formula.

Acid value (mgKOH/g)={(5.611×a×F)/S}/(non-volatile fraction concentration/100)

In the formula, S represents the weighed mass (g) of the sample, a represents the volume consumed (ml) of the 0.1 N alcoholic solution of potassium hydroxide, and F represents the titer of the 0.1 N alcoholic solution of potassium hydroxide.

### <Hydroxyl Value>

About 1 g of the sample was weighed accurately into a stoppered conical flask, and 100 ml of a mixed solvent of toluene and ethanol (volumetric ratio:toluene/ethanol=2/1) was added to dissolve the sample. Subsequently, 5 ml of an acetylation agent (a solution prepared by dissolving 25 g of acetic anhydride in pyridine and then making the solution up to 100 ml) was measured accurately and added to the flask, and the resulting mixture was stirred for about one hour. A phenolphthalein reagent was then added to the solution, and the solution was left to stand for 30 seconds. The solution was then titrated with a 0.1 N alcoholic solution of potassium hydroxide until the solution developed a faint pink color.

The hydroxyl value was determined using the following formula. The hydroxyl value was calculated as a numerical value for the dried-state resin (units:mgKOH/g).

Hydroxyl value(mgKOH/g)=[{(b−a)×F×28.25}/S]/(non-volatile fraction concentration/100)+D

In the formula, S represents the weighed mass (g) of the sample, a represents the volume consumed (ml) of the 0.1 N alcoholic solution of potassium hydroxide, b represents the volume consumed (ml) of the 0.1 N alcoholic solution of potassium hydroxide in a blank test, F represents the titer of the 0.1 N alcoholic solution of potassium hydroxide, and D represents the acid value (mgKOH/g).

### 2. Preparation of Matte Coating Compositions and Decorative Materials

Silicas (A1) to (A7), silicas (B1) to (B3), isocyanate curing agents 1 to 3, and other resin components used in the examples and comparative examples described below were as follows.

### (Silicas Used in Matte Coating Compositions)

Silica (A1): average particle size: 4 specific surface area: 130 m²/g, primary particle size: 23 nm, product name: Hi-Sil T-152 (manufactured by PPG Industries, Inc.)

Silica (A2): average particle size: 8.3 μm, specific surface area: 100 m²/g, primary particle size: 27 nm, product name: Nipsil E150J (manufactured by Tosoh Silica Corporation)

Silica (A3): average particle size: 4.2 μm, specific surface area: 150 m²/g, primary particle size: 18 nm, product name: Nipsil E220A (manufactured by Tosoh Silica Corporation)

Silica (A4): average particle size: 3.9 μm, specific surface area: 500 m²/g, primary particle size: 5.5 nm, product name: Sylysia 550 (manufactured by Fuji Silysia Chemical Ltd.)

Silica (A5): average particle size: 3 μm, specific surface area: 40 m²/g, primary particle size: 68 nm, product name: Mizukasil P-603 (manufactured by Mizusawa Industrial Chemicals, Ltd.)

Silica (A6): average particle size: 6.4 μm, specific surface area: 300 m²/g, primary particle size: 9 nm, product name: Sylysia 370 (manufactured by Fuji Silysia Chemical Ltd.)

Silica (A7): average particle size: 15 μm, specific surface area: 240 m²/g, primary particle size: 11.4 nm, product name: Carplex #30 (manufactured by Evonik Industries AG)

### (Silicas Used in Coating Compositions)

Silica (B1): the same as silica (A6) above.

Silica (B2): average particle size: 5 μm, specific surface area: 180 m²/g, primary particle size: 17 nm, product name: Mizukasil P-803 (manufactured by Mizusawa Industrial Chemicals, Ltd.)

Silica (B3): the same as silica (A7).

The average particle size, the specific surface area and the primary particle size for each silica represent values obtained using the methods described below.

### <Average Particle Size>

A liquid sample was first prepared by dispersing the silica in ethyl acetate. The resulting liquid sample was irradiated with laser light using a particle size distribution analyzer Microtrac HRA manufactured by Nikkiso Co., Ltd., and by measuring the distribution pattern of the intensity of the light scattered as the laser light passes through the liquid, a particle size distribution was obtained. The volumetric median size (50% diameter) was determined from this particle size distribution and used as the average particle size.

### <Specific Surface Area>

Using a FlowSorb III 2310 manufactured by Micromeritics Instrument Corporation, the amount of nitrogen gas adsorption to the silica was measured by the gas flow method, and the specific surface area was then calculated in accordance with the BET method.

### <Primary Particle Size>

Using the specific surface area of the silica obtained by the measurement described above, the primary particle size was calculated using the following formula 1.

Particle size d (nm)=6,000/specific surface area S (m²/g)·density ρ (g/cm³) [Formula 1]

### (Binder Components)

### (Resin Components)

Acrylic polymers (1) to (9): the acrylic polymers obtained in Synthesis Examples 1 to 9, wherein the acrylic polymers (1) to (8) correspond with acrylic polyols.

Polyester polyol: hydroxyl value: 213, solid fraction: 100%, product name: Nippolan 1100, manufactured by Tosoh Corporation.

Alkyd resin: hydroxyl value: 60, solid fraction: 70%, product name: Arakyd 7053, manufactured by Arakawa Chemical Industries, Ltd., used diluted in butyl acetate.

Urethane resin: solid fraction: 25%, product name: Liourethane JRU500A, manufactured by Toyo Ink Co., Ltd.,

Cellulose resin: solid fraction: 30% by weight, product name: CAB381-20, manufactured by Eastman Chemical Company, used as a solution in methyl ethyl ketone.

### (Curing Agents)

Isocyanate curing agent 1: an HDI-based isocyanurate, solid fraction: 100%, NCO content: 22%, product name: Basonat HI100, manufactured by BASF Chemicals Co., Ltd.

Isocyanate curing agent 2: a TDI-based adduct, solid fraction: 75%, NCO content: 13%, product name: Desmodur L75, manufactured by Sumika Bayer Urethane Co., Ltd.

Isocyanate curing agent 3: an XDI-based adduct, solid fraction: 75%, NCO content: 11.5%, product name: Takenate D-110N, manufactured by Mitsui Takeda Chemicals, Inc.

### (Polymerizable Oligomers, Monomers)

Pentaerythritol triacrylate: product name: Miramer M340, manufactured by Miwon Specialty Chemical Co., Ltd.

Dipentaerythritol hexaacrylate: product name: Miramer M600, manufactured by Miwon Specialty Chemical Co., Ltd.

Urethane acrylate: product name: UA-306H, manufactured by Kyoeisha Chemical Co., Ltd.

### Example 1

### <Matte Coating Composition>

A matte coating composition was prepared in accordance with the blend ratio shown in Table 2. More specifically, the following method was used. A mixing device with a stirring blade was charged with 50 parts of the acrylic polyol (3) obtained in Synthesis Example 3, 10 parts of the polyester polyol, 10 parts of the silica (A1), 5 parts of the alkyd resin (equivalent to a solid fraction of 3.5 parts) and a solvent (ethyl acetate/methyl ethyl ketone=1/1), and the resulting mixture was stirred. Subsequently, 12.1 parts of the isocyanate curing agent 1 was added to the mixture and stirred. In this manner, a heat-curable matte coating composition (1) with a final solid fraction of 40% was obtained.

### <Coating Composition>

A coating composition was prepared in accordance with the blend ratio shown in Table 4. More specifically, the following method was used. A mixing device with a stirring blade was charged with 50 parts of the acrylic polyol (5) obtained in Synthesis Example 1, 5.5 parts of the silica (B1) (the same as the silica (A6)), and a solvent (ethyl acetate/methyl ethyl ketone=1/1), 8.2 parts of the isocyanate curing agent 1 was then added, and the resulting mixture was stirred. In this manner, a heat-curable coating composition (1) with a final solid fraction of 40% was obtained.

### <Preparation of Decorative Material>

### (Formation of First Surface Protective Layer)

Using a gravure printing device, an oil-based gravure ink PCNT921-black manufactured by Toyo Ink Co., Ltd. was printed onto the surface of a thin paper having a basis weight of 30 g/m². Subsequently, the previously prepared matte coating composition (1) was applied to the printed ink layer surface of thus obtained printed item in an amount sufficient to form a coating amount following heat drying of 4 g/m². A cured coating film was then formed by heating and drying at 160° C., thus obtaining a coated item (1a) having a first surface protective layer. The coating film thickness of the first surface protective layer (cured coating film) was 4 μm.

### (Formation of Second Surface Protective Layer)

The previously prepared coating composition (1) was applied to the first surface protective layer of the coated item (1a) prepared in the manner described above so as to partially cover the first surface protective layer with an average coating amount following heat drying of 6 g/m². The applied coating film was then cured by heating and drying at 160° C., thus forming a second surface protective layer. The coating film thickness of the second surface protective layer (cured coating film) was 6 μm.

Using the method described above, a decorative material was obtained having a first surface protective layer and a partial second surface protective layer on a printed ink layer. The thus obtained decorative material was aged at 40° C. for two days, and then used in each of the evaluations described below.

### Examples 2 to 23, Comparative Examples 1 to 6

With the exception of altering the blend ratios for the matte coating composition (1) and the coating composition (1) from Example 1 to the blend ratios shown in Table 2 to Table 4, matte coating compositions (2) to (29) and coating compositions (2) to (7) were obtained in the same manner as Example 1. The thus obtained matte coating compositions and coating compositions were each prepared with a solid fraction of 40% using a solvent (ethyl acetate/methyl ethyl ketone=1/1).

Subsequently, as shown in Tables 5 to 7, the matte coating compositions were each used to form a first surface protective layer in the same manner as Example 1, thus obtaining coated items (2a) to (23a), and (33a) to (38a). Then, using each of the coating compositions, a second surface protective layer was formed on top of the first surface protective layer in the same manner as Example 1, thus obtaining decorative materials of Examples 2 to 23 and decorative materials of Comparative Examples 1 to 6. Each of the thus obtained decorative materials was aged at 40° C. for two days, and then used in each of the evaluations described below.

The curing type shown for the resins listed in Tables 2 to 4 indicates the types of curing that can potentially be used. On the other hand, the curing type shown in Tables 5 to 7 indicates the curing method actually used during the curing process.

As shown in Tables 2 to 4, the matte coating compositions (2) to (20) and (24) to (29), and the coating compositions (1) to (5) all contained a heat-curable resin as the binder component, and were therefore able to be cured by heating. In this regard, as shown in Tables 5 and 6, in the formation of the first surface protective layer in Examples 2 to 20, the matte coating compositions (2) to (20) were applied and then heated and dried at 160° C. to obtain a cured coating film in the same manner as Example 1. The amount added of the isocyanate curing agent was adjusted so as to provide 1.0 equivalents of the isocyanate curing agent relative to the combined amount of the acrylic polyol and the polyester polyol. On the other hand, in the formation of the second surface protective layer, the coating composition (1) was applied, and was then heated and dried at 160° C. to obtain a cured coating film in the same manner as Example 1.

In contrast, in those cases where the binder component contains an ionizing radiation-curable resin, such as the matte coating compositions (21) and (22), the composition can be cured by irradiation with ultraviolet radiation (UV) and/or an electron beam (EB).

In this regard, formation of the first surface protective layer in Example 21 relates to an embodiment in which curing is performed by irradiation with ultraviolet radiation. In Example 21, a photopolymerization initiator (product name: Darocur 1173, an alkylphenone-based initiator manufactured by Nagase & Co., Ltd.) was also added to the matte coating composition (21). The amount added of the photopolymerization initiator was 4 parts per 100 parts of the ultraviolet-curable resin in the coating composition. The matte coating composition containing this type of photopolymerization initiator was applied, and the coating film was then cured by irradiation with ultraviolet radiation under conditions of 120 W and 200 mJ/cm², thus forming a cured coating film and obtaining a decorative material. The irradiation of ultraviolet radiation was performed using a UVC2515 apparatus manufactured by Ushio Inc.

Further, formation of the first surface protective layer in Example 22 relates to an embodiment in which curing is performed by irradiation with an electron beam. Making the matte coating composition electron beam-curable (EB-curable) does not require a photopolymerization initiator. Accordingly, in Example 22, the matte coating composition (22) was applied, and the coating film was then cured by irradiation with an electron beam under conditions of 125 kV and 30 kGy, thus forming a cured coating film. The electron beam irradiation was performed using a CB250/30/180L apparatus manufactured by Eye Electron Beam Co., Ltd.

In the matte coating composition (23), because the binder component includes a heat-curable resin and an ionizing radiation-curable resin, the composition can be cured with at least one method selected from the group consisting of heat curing (heat), ultraviolet radiation (UV) and electron beam irradiation (EB). In this regard, formation of the first surface protective layer in Example 23 relates to an embodiment in which curing is performed by heating and ultraviolet radiation irradiation. In Example 23, a photopolymerization initiator (product name: Darocur 1173, manufactured by Nagase & Co., Ltd.) was also added to the matte coating composition (23). The amount added of the photopolymerization initiator was 4 parts per 100 parts of the ultraviolet-curable resin in the coating composition. In the step of forming the cured coating film, the coating film of the first surface protective layer was first semi-cured by heating and drying at 160° C. Subsequently, at the same time as the formation of the second surface protective layer, ultraviolet radiation was irradiated under conditions of 120 W and 200 mJ/cm², thus forming the cured coating films of both the first and second surface protective layers to obtain the decorative material. The thus obtained decorative material was aged at 40° C. for two days, and then used in each of the evaluations described below.

### Examples 24 to 32

As shown in Table 6, with the exception of altering part of the composition of the first surface protective layer and/or the second surface protective layer from the decorative material produced in Example 1, decorative materials were produced in the same manner as Example 1. In the case of Examples 24 to 27, 30 and 32, the coating compositions (2) to (5) are heat-curable compositions, and each of the cured coating films was formed by performing heating and drying at 160° C. to obtain a decorative material. Further, in Examples 28, 29 and 31, the coating compositions (6), (7) and (1) are ultraviolet-curable compositions. Accordingly, a photopolymerization initiator was added to the coating composition in the same manner as Example 1. Each of these coating compositions containing the photopolymerization initiator was irradiated with ultraviolet radiation under conditions of 120 W and 200 mJ/cm², thus forming a cured coating film and obtaining a decorative material.

The decorative materials of Examples 24 to 32 obtained in the manner described above were each aged at 40° C. for two days, and then used in each of the evaluations described below.

### 3. Evaluation of Matte Coating Compositions and Decorative Materials

The matte coating compositions and the decorative materials were subjected to each of the evaluations described below. The evaluation results are shown in Tables 5 to 7. The liquid stability of each of the matte coating compositions and coating compositions is shown in Tables 2 to 4.

In the decorative materials actually produced in each example and each comparative example, the surface area of the exposed portion of the low-gloss first surface protective layer (the portion where the high-gloss second surface protective layer did not exist) was small, and measurement of the specular glossiness was difficult. Accordingly, for the evaluation of the specular glossiness and the like, a measurement sample corresponding with each example and each comparative example was also prepared and evaluated.

### (Preparation of the Measurement Sample)

A substrate having a printed ink layer was prepared in the same manner as each of the examples and comparative examples, and the matte coating composition was then applied to the printed ink layer in a strip having a width of 10 cm, which was then cured to obtain a cured coating firm (first surface protective layer). Subsequently, the high-gloss coating composition was printed on top of the first surface protective layer with a width of 5 cm, the applied coating film was cured to form a cured coating film (second surface protective layer), and aging was then performed. In this manner, a decorative material measurement sample was obtained, having a structure in which the first surface protective layer was exposed at the material surface across a width of 5 cm. The thickness of each cured coating film is shown in Tables 5 to 7.

### <Evaluation Items>

### (60° Specular Glossiness)

Using a BYK-Gardner micro-gloss gloss meter manufactured by Toyo Seiki Seisaku-sho, Ltd., the first surface protective layer and the second surface protective layer of the above measurement sample were each measured for specular glossiness at 60° in accordance with JIS8741 (1997).

### (Lightness)

Using the measurement sample described above, a spectral densitometer manufactured by X-Rite, Inc. was used to measure the L* value in accordance with JIS8781-4 (2013).

### (Solvent Resistance)

An absorbent cotton soaked in isopropyl alcohol was rubbed 100 times back and forth across the surface of the first surface protective layer of the above measurement sample, and the surface was then evaluated visually for change. The evaluation criteria were as follows, with a grade of B or higher indicating a practically applicable level.

Evaluation Criteria

A: no change

B: slight changes in external appearance and gloss

C: obvious changes in external appearance and gloss

D: holes appear in coating film surface

### (Scratch Resistance)

A piece of calico was rubbed 1,000 times back and forth across the surface of the first surface protective layer of the above measurement sample, and the coating film surface was evaluated visually for change. The evaluation criteria were as follows, with a grade of B or higher indicating a practically applicable level.

Evaluation Criteria

A: no change

B: slight scratches

C: obvious scratches

### (Design Aesthetics)

The design aesthetics of the decorative material obtained in each example and each comparative example was evaluated visually on the basis of the three-dimensional feel and the transparency of the decorative material. The evaluation criteria were as follows, with a grade of C or higher indicating a practically applicable level.

Evaluation Criteria

A: three-dimensional feel particularly prominent, as well as excellent transparency

B: three-dimensional feel prominent, as well as excellent transparency

C: some three-dimensional feel, as well as excellent transparency

D: three-dimensional feel slightly inferior, but excellent transparency

E: three-dimensional feel slightly inferior, and transparency also slightly inferior

F: three-dimensional feel poor, and transparency also slightly inferior

### (Liquid Stability)

Using a Zahn cup, the viscosity at 25° C. of the matte coating composition of each example and each comparative example was measured immediately following preparation, and then after standing for one day at 40° C., and the change in viscosity was evaluated. The evaluation criteria were as follows, with a grade of B or higher indicating a practically applicable level.

Evaluation Criteria

A: no change

B: change of 5 seconds or less

C: change of 6 to 10 seconds

D: change of 11 seconds or more

As is evident from the results shown in Tables 5 to 7, when the silica added to the matte coating composition has an average particle size, an amount added, and a primary particle size that satisfy the prescribed ranges (Examples 1 to 32), the solvent resistance and scratch resistance are excellent, and it is clear that compared with matte coating compositions containing silica having values outside these ranges (Comparative Examples 1 to 6), a low-gloss surface protective layer is able to be formed while maintaining favorable lightness. Moreover, it is also evident that by combining a first surface protective layer formed from a cured coating film of this type of matte coating composition with a second surface protective layer formed from a cured coating film of a high-gloss coating composition, the gloss difference enables an uneven three-dimensional feel to be portrayed, meaning a decorative material with superior design aesthetics can be provided.

More specifically, by comparison of Examples 1 to 32 with Comparative Examples 1 and 2, it is evident that by using a specific amount of a silica having the particle size characteristics prescribed above, good transparency can be maintained. Further, by comparison of Examples 1 to 32 with Comparative Examples 2 to 6, it is evident that the combination of the average particle size and primary particle size of the silica is important. In particular, by comparison of Example 1 and Comparative Example 3, it is clear that a difference in the primary particle size can cause significant differences in the gloss, the lightness and the design aesthetics.

TABLE 1

| | Synthesis Example | | | | | | | | |
|---|---|---|---|---|---|---|---|---|---|
| | 1 | 2 | 3 | 4 | 5 | 6 | 7 | 8 | 9 |
| Acrylic polymer | (1) | (2) | (3) | (4) | (5) | (6) | (7) | (8) | (9) |
| Acrylic acid | 1.6 | 2 | 0.2 | 2.4 | 2.8 | 1 | 2 | 2 | 2 |
| Methyl methacrylate | 14.4 | 39 | 35.8 | 39 | 39 | 19 | 24 | 10 | 39 |
| Styrene | 20 | | | | | 7 | 5 | 20 | |
| 2-hydroxyethyl methacrylate | 4 | 44 | 20 | 30 | 34 | 49 | 45 | 29 | |
| Ethyl methacrylate | | | | | | 8 | 8 | | |
| Butyl methacrylate | 60 | 15 | 44 | 28.6 | 24.2 | 16 | 16 | 39 | 59 |
| AIBN | 2 | 3 | 2 | 1.5 | 2 | 2 | 1.2 | 3 | 2 |
| Subtotal | 102 | 103 | 102 | 101.5 | 102 | 102 | 101.2 | 103 | 102 |
| Hydroxyl value (mgKOH/g) | 17.2 | 189.7 | 86.2 | 129.3 | 146.6 | 211.2 | 194 | 125 | 0 |
| Acid value (mgKOH/g) | 12.5 | 15.6 | 1.6 | 18.7 | 21.8 | 7.8 | 15.6 | 12.5 | 18.7 |
| Weight-average molecular | 33,000 | 11,000 | 30,000 | 47,000 | 31,000 | 30,000 | 55,000 | 9,500 | 30,000 |
| weight | | | | | | | | | |
| Solid fraction (%) | 33 | 33 | 33 | 33 | 33 | 33 | 33 | 33 | 33 |

The acrylic polymers (1) to (8) are acrylic polyols.

TABLE 2

| | Matte coating composition | | | | | | | | | | | | | | | |
|---|---|---|---|---|---|---|---|---|---|---|---|---|---|---|---|---|
| Component | (1) | (2) | (3) | (4) | (5) | (6) | (7) | (8) | (9) | (10) | (11) | (12) | (13) | (14) | (15) | (16) |
| Silica (A1) (solid fraction) | 10 | | | 8 | 11.5 | 7 | 10 | 10 | 10 | 10 | 10 | 10 | 10 | 10 | 10 | 10 |
| Silica (A2) (solid fraction) | | 10 | | | | | | | | | | | | | | |
| Silica (A3) (solid fraction) | | | 10 | | | | | | | | | | | | | |
| Silica (A4) (solid fraction) | | | | | | | | | | | | | | | | |
| Silica (A5) (solid fraction) | | | | | | | | | | | | | | | | |
| Silica (A6) (solid fraction) | | | | | | | | | | | | | | | | |
| Silica (A7) (solid fraction) | | | | | | | | | | | | | | | | |
| Acrylic polyol (1) | | | | | | 40 | | | | | | | | | | |
| Acrylic polyol (2) | | | | | | | 40 | | | | | | | | | |
| Acrylic polyol (3) | 50 | 50 | 50 | 50 | 50 | | | | | | | | | | | |
| Acrylic polyol (4) | | | | | | | | 40 | | | | | | | | |
| Acrylic polyol (5) | | | | | | | | | 40 | | | | | | | |
| Acrylic polyol (6) | | | | | | | | | | 40 | | | | | | |
| Acrylic polyol (7) | | | | | | | | | | | 40 | | | | | |
| Acrylic polyol (8) | | | | | | | | | | | | 40 | | | | |
| Acrylic polymer (9) | | | | | | | | | | | | | 60 | | | |
| Polyester polyol (NV100) | 10 | 10 | 10 | 10 | 10 | 10 | 10 | 10 | 10 | 10 | 10 | 10 | 10 | 10 | 10 | 10 |
| Alkyd resin (NV70) | 5 | | | | | | | | | | | | | 30 | | |
| Urethane resin (NV25) | | | | | | | | | | | | | | | 80 | |
| Cellulose resin (NV30) | | 5 | | | | | | | | | | | | | | 60 |
| Isocyanate curing agent 1 | 12.1 | 12.1 | 12.1 | 12.1 | 12.1 | 8.01 | 15.76 | 13.05 | 13.82 | 16.72 | 15.95 | 12.85 | 7 | 8 | 7 | 7 |
| Isocyanate curing agent 2 | | | | | | | | | | | | | | | | |
| Isocyanate curing agent 3 | | | | | | | | | | | | | | | | |
| Pentaerythritol triacrylate | | | | | | | | | | | | | | | | |
| Dipentaerythritol hexaacrylate | | | | | | | | | | | | | | | | |
| Urethane acrylate | | | | | | | | | | | | | | | | |
| Curing type | heat | heat | heat | heat | heat | heat | heat | heat | heat | heat | heat | heat | heat | heat | heat | heat |
| Silica content (%) | 23.8 | 24.9 | 25.9 | 20.7 | 29.8 | 22.4 | 25.7 | 27.6 | 27.0 | 25.1 | 25.5 | 27.7 | 27.2 | 25.6 | 27.0 | 26.3 |
| Liquid stability evaluation | A | A | A | A | A | A | A | A | A | A | A | A | A | A | A | A |

TABLE 3

| | Matte coating composition | | | | | | | | | | | | |
|---|---|---|---|---|---|---|---|---|---|---|---|---|---|
| Component | (17) | (18) | (19) | (20) | (21) | (22) | (23) | (24) | (25) | (26) | (27) | (28) | (29) |
| Silica (A1) (solid fraction) | 10 | 10 | 10 | 6 | 10 | 10 | 10 | 6.5 | 11 | | | | |
| Silica (A2) (solid fraction) | | | | | | | | | | | | | |
| Silica (A3) (solid fraction) | | | | | | | | | | | | | |
| Silica (A4) (solid fraction) | | | | | | | | | | 9 | | | |
| Silica (A5) (solid fraction) | | | | | | | | | | | 9 | | |
| Silica (A6) (solid fraction) | | | | | | | | | | | | 9 | |
| Silica (A7) (solid fraction) | | | | | | | | | | | | | 9 |
| Acrylic polyol (1) | | | | | | | | | | | | | |
| Acrylic polyol (2) | | | | | | | | | | | | | |
| Acrylic polyol (3) | 40 | 40 | 40 | 50 | | | 16 | 40 | 40 | 40 | 40 | 40 | 40 |
| Acrylic polyol (4) | | | | | | | | | | | | | |
| Acrylic polyol (5) | | | | | | | | | | | | | |
| Acrylic polyol (6) | | | | | | | | | | | | | |
| Acrylic polyol (7) | | | | | | | | | | | | | |
| Acrylic polyol (8) | | | | | | | | | | | | | |
| Acrylic polymer (9) | | | | | | | | | | | | | |
| Polyester polyol (NV100) | 10 | 10 | 10 | 0 | | | | 10 | 10 | 10 | 10 | 10 | 10 |
| Alkyd resin (NV70) | | | | | | | | | | | | | |
| Urethane resin (NV25) | | | | | | | | | | | | | |
| Cellulose resin (NV30) | | | | | | | | | | | | | |
| Isocyanate curing agent 1 | | | 5.55 | 4.84 | | | 12 | 11.11 | 11.11 | 11.11 | 11.11 | 11.11 | 11.11 |
| Isocyanate curing agent 2 | 25.07 | | 12.53 | | | | | | | | | | |
| Isocyanate curing agent 3 | | 28.34 | | | | | | | | | | | |
| Pentaerythritol triacrylate | | | | | 40 | | | | | | | | |
| Dipentaerythritol hexaacrylate | | | | | | 20 | 30 | | | | | | |
| Urethane acrylate | | | | | | 20 | | | | | | | |
| Curing type | heat | heat | heat | heat | UV/EB | UV/EB | UV/EB/heat | heat | heat | heat | heat | heat | heat |
| Silica content (%) | 23.8 | 22.5 | 26.2 | 28.1 | 25.0 | 25.0 | 22.6 | 19.0 | 32.1 | 26.2 | 26.2 | 26.2 | 26.2 |
| Liquid stability evaluation | B | B | A | A | A | A | A | A | A | A | A | A | A |

TABLE 4

| | Coating composition | | | | | | |
|---|---|---|---|---|---|---|---|
| Component | (1) | (2) | (3) | (4) | (5) | (6) | (7) |
| Silica (B1) | 5.5 | | | | | | 5 |
| Silica (B2) | | 2 | | 4 | | 5 | |
| Silica (B3) | | | 5 | | | | |
| Acrylic polyol (2) | | | | 50 | 50 | | |
| Acrylic polyol (5) | 50 | 50 | 50 | | | | |
| Isocyanate curing | 8.2 | | | 10.7 | 10.7 | | |
| agent 1 | | | | | | | |
| Isocyanate curing | | 18.6 | | | | | |
| agent 2 | | | | | | | |
| Isocyanate curing | | | 21.0 | | | | |
| agent 3 | | | | | | | |
| Dipentaerythritol | | | | | | 40 | 40 |
| hexaacrylate | | | | | | | |
| Curing type | heat | heat | heat | heat | heat | UV/EB | UV/EB |
| Silica content (%) | 22.2 | 6.6 | 15.5 | 14.7 | 0.0 | 12.5 | 12.5 |
| Liquid stability | A | A | A | A | A | A | A |

TABLE 5

| | | Example | | | | | | | | | | | | | | | |
|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 | 16 |
| First surface | Matte coating | (1) | (2) | (3) | (4) | (5) | (6) | (7) | (8) | (9) | (10) | (11) | (12) | (13) | (14) | (15) | (16) |
| protective | composition | | | | | | | | | | | | | | | | |
| layer | Film thickness (μm) | 4 | 4 | 4 | 4 | 4 | 4 | 4 | 4 | 4 | 4 | 4 | 4 | 4 | 4 | 4 | 4 |
| | Curing type | heat | heat | heat | heat | heat | heat | heat | heat | heat | heat | heat | heat | heat | heat | heat | heat |
| | Coated item | 1a | 2a | 3a | 4a | 5a | 6a | 7a | 8a | 9a | 10a | 11a | 12a | 13a | 14a | 15a | 16a |
| Second | Coating composition | (1) | (1) | (1) | (1) | (1) | (1) | (1) | (1) | (1) | (1) | (1) | (1) | (1) | (1) | (1) | (1) |
| surface | Film thickness (μm) | 6 | 6 | 6 | 6 | 6 | 6 | 6 | 6 | 6 | 6 | 6 | 6 | 6 | 6 | 6 | 6 |
| protective | Curing type | heat | heat | heat | heat | heat | heat | heat | heat | heat | heat | heat | heat | heat | heat | heat | heat |
| layer | Coated item | 1b | 2b | 3b | 4b | 5b | 6b | 7b | 8b | 9b | 10b | 11b | 12b | 13b | 14b | 15b | 16b |
| Substrate | | paper | paper | paper | paper | paper | paper | paper | paper | paper | paper | paper | paper | paper | paper | paper | paper |
| Evaluations | Specular glossiness | 0.6 | 0.6 | 0.6 | 1 | 0.3 | 0.7 | 0.5 | 0.4 | 0.4 | 0.5 | 0.5 | 0.4 | 0.5 | 1 | 0.7 | 0.7 |
| | (first surface | | | | | | | | | | | | | | | | |
| | protective layer) | | | | | | | | | | | | | | | | |
| | Lightness | 18 | 20 | 19 | 18 | 20 | 20 | 20 | 20 | 20 | 23 | 22 | 23 | 24 | 22 | 21 | 22 |
| | (first surface | | | | | | | | | | | | | | | | |
| | protective layer) | | | | | | | | | | | | | | | | |
| | Specular glossiness | 7 | 7 | 7 | 8 | 6 | 7 | 7 | 6 | 7 | 7 | 7 | 7 | 7 | 8 | 7 | 7 |
| | (second surface | | | | | | | | | | | | | | | | |
| | protective layer) | | | | | | | | | | | | | | | | |
| | Solvent resistance | A | A | A | A | A | A | A | A | A | A | A | A | B | B | B | B |
| | Scratch resistance | B | B | B | B | B | B | B | B | B | B | B | B | B | B | B | B |
| | Design aesthetics | B | B | B | B | B | B | B | B | B | C | C | C | C | C | C | C |

TABLE 6

| | | Example | | | | | | | | | | | | | | | |
|---|---|---|---|---|---|---|---|---|---|---|---|---|---|---|---|---|---|
| | | 17 | 18 | 19 | 20 | 21 | 22 | 23 | 24 | 25 | 26 | 27 | 28 | 29 | 30 | 31 | 32 |
| First surface | Matte coating | (17) | (18) | (19) | (20) | (21) | (22) | (23) | (1) | (1) | (1) | (1) | (1) | (1) | (1) | (1) | (2) |
| protective | composition | | | | | | | | | | | | | | | | |
| layer | Film thickness | 4 | 4 | 4 | 4 | 4 | 4 | 4 | 4 | 4 | 4 | 4 | 4 | 4 | 4 | 4 | 12 |
| | (μm) | | | | | | | | | | | | | | | | |
| | Curing type | heat | heat | heat | heat | UV | EB | UV/heat | heat | heat | heat | heat | heat | heat | heat | UV | heat |
| | Coated item | 17a | 18a | 19a | 20a | 21a | 22a | 23a | 24a | 25a | 26a | 27a | 28a | 29a | 30a | 31a | 32a |
| Second | Coating | (1) | (1) | (1) | (1) | (1) | (1) | (1) | (2) | (3) | (4) | (5) | (6) | (7) | (1) | (1) | (1) |
| surface | composition | | | | | | | | | | | | | | | | |
| protective | Film thickness | 6 | 6 | 6 | 6 | 8 | 8 | 8 | 6 | 6 | 6 | 6 | 6 | 6 | 6 | 6 | 6 |
| layer | (μm) | | | | | | | | | | | | | | | | |
| | Curing type | heat | heat | heat | heat | UV | EB | UV | heat | heat | heat | heat | UV | UV | heat | UV | heat |
| | Coated item | 17b | 18b | 19b | 20b | 21b | 22b | 23b | 24b | 25b | 26b | 27b | 28b | 29b | 30b | 31b | 32b |
| Substrate | | paper | paper | paper | paper | paper | paper | paper | paper | paper | paper | paper | paper | paper | film | film | paper |
| Evaluations | Specular | 0.6 | 0.6 | 0.5 | 0.4 | 0.5 | 0.5 | 0.7 | 0.6 | 0.6 | 0.6 | 0.6 | 0.6 | 0.6 | 2 | 2 | 8 |
| | glossiness | | | | | | | | | | | | | | | | |
| | (first surface | | | | | | | | | | | | | | | | |
| | protective layer) | | | | | | | | | | | | | | | | |
| | Lightness | 26 | 25 | 24 | 25 | 20 | 20 | 19 | 18 | 18 | 18 | 18 | 18 | 18 | 22 | 22 | 22 |
| | (first surface | | | | | | | | | | | | | | | | |
| | protective layer) | | | | | | | | | | | | | | | | |
| | Specular | 7 | 7 | 7 | 7 | 8 | 9 | 9 | 15 | 10 | 12 | 22 | 13 | 12 | 10 | 10 | 20 |
| | glossiness | | | | | | | | | | | | | | | | |
| | (second surface | | | | | | | | | | | | | | | | |
| | protective layer) | | | | | | | | | | | | | | | | |
| | Solvent resistance | A | A | A | A | A | A | A | A | A | A | A | A | A | A | A | A |
| | Scratch resistance | B | B | B | B | A | A | A | B | B | B | B | A | A | B | A | B |
| | Design aesthetics | C | C | C | C | B | B | B | A | B | B | A | B | B | B | B | C |

TABLE 7

| | | Comparative Example | | | | | |
|---|---|---|---|---|---|---|---|
| | | 1 | 2 | 3 | 4 | 5 | 6 |
| First surface | Matte coating composition | (24) | (25) | (26) | (27) | (28) | (29) |
| protective | Film thickness (μm) | 4 | 4 | 4 | 4 | 4 | 4 |
| layer | Curing type | heat | heat | heat | heat | heat | heat |
| | Coated item | 33a | 34a | 35a | 36a | 37a | 38a |
| Second surface | Coating composition | (1) | (1) | (1) | (1) | (1) | (1) |
| protective | Film thickness (μm) | 6 | 6 | 6 | 6 | 6 | 6 |
| layer | Curing type | heat | heat | heat | heat | heat | heat |
| | Coated item | 33b | 34b | 35b | 36b | 37b | 38b |
| Substrate | | paper | paper | paper | paper | paper | paper |
| Evaluations | Specular glossiness (first | 0.3 | 1.5 | 8 | 10 | 6 | 6 |
| | surface protective layer) | | | | | | |
| | Lightness (first surface | 32 | 30 | 27 | 22 | 27 | 26 |
| | protective layer) | | | | | | |
| | Specular glossiness (second | 7 | 10 | 14 | 15 | 12 | 12 |
| | surface protective layer) | | | | | | |
| | Solvent resistance | A | A | A | A | A | A |
| | Scratch resistance | B | B | B | B | B | B |
| | Design aesthetics | E | E | E | D | E | D |

What is claimed is:

1. A matte coating composition, which can be used in a decorative material having, in order, a substrate, a printed ink layer, a first surface protective layer formed from a cured coating film of the matte coating composition, and a second surface protective layer that is provided partially covering the first surface protective layer and has a higher gloss than the first surface protective layer, wherein
the matte coating composition comprises a silica and a binder component, and is at least one of heat-curable and ionizing radiation-curable,
the silica has an average particle size determined by a laser diffraction method of 3 to 10 μm, and a primary particle size calculated from a specific surface area of 10 to 50 nm, and
an amount of the silica, relative to a resin solid fraction of the matte coating composition, is from 20 to 30% by weight.

2. The matte coating composition according to claim 1, wherein the binder component comprises a heat-curable resin containing an acrylic polyol and a polyester polyol, and an isocyanate curing agent.

3. The matte coating composition according to claim 2, wherein the acrylic polyol has a weight-average molecular weight of 10,000 to 50,000, and a hydroxyl value of 50 to 200 mgKOH/g.

4. The matte coating composition according to claim 2, wherein the isocyanate curing agent comprises one or more compounds selected from the group consisting of hexamethylene diisocyanate, toluene diisocyanate, xylylene diisocyanate, isophorone diisocyanate, and derivatives thereof.

5. The matte coating composition according to claim 1, wherein the binder component comprises an ionizing radiation-curable resin containing a polyfunctional (meth)acrylate.

6. A decorative material having, in order, a substrate, a printed ink layer, a first surface protective layer, and a second surface protective layer provided partially covering the first surface protective layer, wherein
the first surface protective layer is formed from a cured coating film of a matte coating composition, and the second surface protective layer is formed from a cured coating film of a coating composition having a higher gloss than the first surface protective layer,
the matte coating composition comprises a silica and a binder component, and is at least one of heat-curable and ionizing radiation-curable,
the silica has an average particle size determined by a laser diffraction method of 3 to 10 μm, and a primary particle size calculated from a specific surface area of 10 to 50 nm,
an amount of the silica, relative to a resin solid fraction of the matte coating composition, is from 20 to 30% by weight, and
a specular glossiness of the first surface protective layer at an incident angle of 60° is 5 or less.

7. The decorative material according to claim 6, wherein the substrate is a paper.

8. The decorative material according to claim 6, wherein the first surface protective layer has a thickness of 2 to 10 μm.

9. The decorative material according to claim 6, wherein the coating composition used for forming the second surface protective layer is at least one of heat-curable and ionizing radiation-curable.

10. The decorative material according to claim 9, wherein the coating composition comprises an ionizing radiation-curable resin containing a polyfunctional (meth)acrylate.

11. The decorative material according to claim 6, wherein a specular glossiness of the second surface protective layer at an incident angle of 60° is at least twice as large as the specular glossiness of the first surface protective layer at an incident angle of 60°.

12. A method for producing a decorative material having, in order, a substrate, a printed ink layer, a first surface protective layer formed from a cured coating film of a matte coating composition, and a second surface protective layer that is provided partially covering the first surface protective layer and has a higher gloss than the first surface protective layer, the method comprising:
(a) a step of forming a printed ink layer by applying an ink composition to a substrate,
(b) a step of forming a first surface protective layer by applying the matte coating composition of claim 1 to an entire upper surface of the printed ink layer, and then curing the matte coating composition, and
(c) a step of forming a second surface protective layer by applying a coating composition that is at least one of heat-curable and ionizing radiation-curable so as to partially cover an upper surface of the first surface protective layer, and then curing the coating composition.

13. The method for producing a decorative material according to claim 12, wherein
in the step (b), the matte coating composition is both heat-curable and ionizing radiation-curable, and the curing is performed by heating, and
in the step (c), the coating composition is ionizing radiation-curable, and the curing is performed by irradiation with ionizing radiation.

14. The method for producing a decorative material according to claim 12, wherein
in the step (b), the matte coating composition is heat-curable, and the curing is performed by heating, and
in the step (c), the coating composition is heat-curable, and the curing is performed by heating.
